(19) United States
(12) Patent Application Publication
(10) Pub. No.: US 2002/0002481 A1
(43) Pub. Date: Jan. 3, 2002

(54) Information processing apparatus for management of documents relevant to patent application

(76) Inventors: Hirokazu Uchio, Tokyo (JP); Toru Tsuboi, Kanagawa (JP); Masaaki Ishii, Kanagawa (JP); Satoru Motohashi, Chiba (JP)

Correspondence Address: Robin, Blecker & Daley, 330 Madison Avenue, New York, NY, 10017, US

(21) Appl. No.: 09/852,578

(22) Filed: May 10, 2001

(30) Foreign Application Priority Data
May 16, 2000 (JP) 143351/2000 (PAT.
May 16, 2000 (JP) 143353/2000 (PAT.
May 18, 2000 (JP) 146432/2000 (PAT.
Jun. 5, 2000 (JP) 167457/2000 (PAT.

(51) Int. Cl. G06F 17/60

(52) U.S. Cl. 705/9

(57) ABSTRACT

To provide an information processing apparatus for efficiently managing documents and various procedures relating to a patent application. Information relating to a patent application is accumulated in a database for each case, and managed for due date. When an inventor has to study a case, a request to study the case is issued to the inventor through a network, and the state of the study by the inventor is checked through the network. Furthermore, a case is transferred to request a third party to study the case, and the transfer of document data overseas is managed according to laws and regulations.

### BACKGROUND OF THE INVENTION

1. Field of the Invention

The present invention relates to an information processing apparatus, an information processing method, and a program storage medium, and more specifically to an information processing apparatus, an information processing method, and a program storage medium having the function of managing documents.

2. Related Background Art

Recently, an increasing number of patent-related documents have been stored and processed as electronic data. The data are normally transmitted and received using IT technology in issuing the publication of Patent Office using CD-ROM as a medium, storing registration publications as electronic data, filing an application with Patent Office through a network, receiving documents from Patent Office, etc.

Furthermore, a retrieval system, publication of various information, etc. have been widely performed through Internet.

On the other hand, enterprises have designed their own computer systems for managing their intellectual property such as patents, utility models, etc. In most of the systems, data of bibliographic information such as the filing date, the application number, etc. for a patent is managed mainly by databases, etc., retrieved, and displayed for necessary term management, etc.

However, the above mentioned documents stored as electronic data, and the progress in a network environment have required electronic management also on the document format, that is, the text of documents to be submitted to Patent Office. Therefore, not only the normal term management, but also the proposal from an inventor, the application and the relevant documents for communications with Patent Office through a network with an attorney have to be appropriately managed.

Especially, when a case is studied sequentially by a plurality of inspectors through a network to generate a document, and if the case cannot be studies and passed to the subsequent inspectors until all documents are prepared, the total studying time considerably increases.

In addition, it is hard to immediately set an environment in which electronic information can be processed totally online including all external organizations. Therefore, in a transitional step, a hybrid system in a communications method using the current facsimile communications can be practically realized.

Furthermore, some submission documents to Patent Office and documents received from Patent Office do not include an applicant. As a result, applicant information may not be displayed in a list of transmission/reception file names. Therefore, in an attorney's office, a clerical staff has to do laborious work in categorizing documents by applicants, thereby causing the problems that documents are transmitted to a wrong applicant, no documents are transmitted mistakenly, etc. That is, it has been necessary to display or print a file stored as electronic data, or to identify an applicant from a ledger, etc. managed by the clerical staff.

Furthermore, when documents are generated and managed through the above mentioned network, and when the information is freely provided overseas without restrictions, the security cannot be guaranteed, or there can be the problem of the infringement of laws and regulations for restricting an export of technical information.

For example, in the U.S., according to Export Administration Regulations, the export of the information is restricted by specifying statistically important technology. In this case, the document management corresponding to the laws and regulations are required. The management is not limited to the U.S., but is adopted also in France, England, etc.

### SUMMARY OF THE INVENTION

The present invention has been achieved to solve the above mentioned problems, and aims at providing an information processing apparatus, an information processing method, and a program storage medium capable of efficiently studying a specified case through a network.

The present invention also aims at providing an information processing apparatus, an information processing method, and a program storage medium capable of efficiently managing intellectual property.

In addition the present invention aims at providing an information processing apparatus, an information processing method, and a program storage medium capable of efficiently fetching facsimile information in a network environment and appropriately managing the information.

Furthermore, the present invention aims at providing an information processing apparatus, an information processing method, and a program storage medium capable of efficiently transmitting document data transmitted to and received from Patent Office to an applicant without fail.

Additionally, the present invention aims at providing an information processing apparatus, an information processing method, and a program storage medium capable of appropriately managing information to be transmitted overseas.

To solve the above mentioned problems, the information processing apparatus according to the present invention communicates information through a network to study a target case, and includes: first communications means for requesting a second inspector from a first inspector to study a target case by attaching first information; and second communications means for transmitting to the second inspector for study of the target case second information not contained in the first information when said first communications means issued a request.

Furthermore, the information processing apparatus according to the present invention fetches facsimile data received through a line into a database, and includes: reception means for receiving facsimile data; and retrieval means for retrieving a specified item in a database from the facsimile data.

The information processing apparatus according to the present invention processes document data by communicating information, and includes: first storage means for storing document transmission/reception record to and from Patent Office; second storage means for storing the document data; acquisition means for acquiring an application number from the transmission/reception record stored in said first storage means or the document data stored in said second storage means; a table storing data indicating correspondence between an application number and an applicant name; and extraction means for extracting document data of a document related to the application number and stored in said second storage means by referring to said table using the application number obtained by said acquisition means as a key.

Furthermore, the information processing apparatus according to the present invention manages a document related to technical information, and includes: determination means for determining a restriction of a law relating to transmission of the technical information to overseas; and control means for controlling transmission of the document to overseas depending on a determination result by said determination means.

Other aspects of the present invention will be apparent from the descriptions of the scope of the detailed description and claims below.

### BRIEF DESCRIPTION OF THE DRAWINGS

FIG. 1 shows a typical configuration of the intellectual property management system according to an embodiment of the present invention;

FIG. 2 shows a flow of information in the intellectual property management system;

FIG. 3 shows an example of an organization in an intellectual property right acquirement section 105, a development right acquirement support section 103, and a research and development section 102;

FIG. 4 shows a method for managing a database in an embodiment of the present invention;

FIG. 5 shows a concept of an action case;

FIG. 6 shows an application case for generating an application document;

FIG. 7 shows a rejection reason response case in which a response to a rejection reason is issued;

FIG. 8 shows a final rejection decision response case in which a response to a decision of a final rejection is issued;

FIG. 9 shows an example of an action study path in an organization configuration as shown in FIG. 3;

FIG. 10 shows an example of an approval path of an action study result;

FIG. 11 shows a table of an action study approval path pattern shown in FIG. 9 and FIG. 10;

FIG. 12 shows a pattern selection table for freely setting a work flow by section (3) and by staff of intellectual property right acquirement section (4) using a pattern table shown in FIG. 11;

FIG. 13 is a flowchart showing the setting of a flow of an action case;

FIG. 14 shows the document follow-up function for an action case;

FIG. 15 is a flowchart of the document follow-up process;

FIG. 16 shows the action case copy function;

FIG. 17 practically shows the method of using a copy case;

FIG. 18 shows an example of an information transmission method in a development section;

FIG. 19 is a flowchart of the invoice process from the intellectual property related office according to the present system;

FIG. 20 shows the typical configuration of the intellectual property management system according to the second embodiment of the present invention;

FIG. 21 shows an example of an OA machines and devices provided for the intellectual property right acquirement support section 106;

FIG. 22 shows a cover page of facsimile;

FIG. 23 is a flowchart of the flow of the process of receiving facsimile;

FIG. 24 is a flowchart of the flow of the process of receiving facsimile;

FIG. 25 shows the configuration of the display screen for a user confirming the process status of an action case;

FIG. 26 shows the configuration of the display screen for a user confirming the process status of an action case;

FIG. 27 is a flowchart showing the method of inputting data into a system when documents are transmitted through a paper medium by facsimile;

FIG. 28 is a flowchart showing the method of inputting data into a system when documents are transmitted through a paper medium by facsimile;

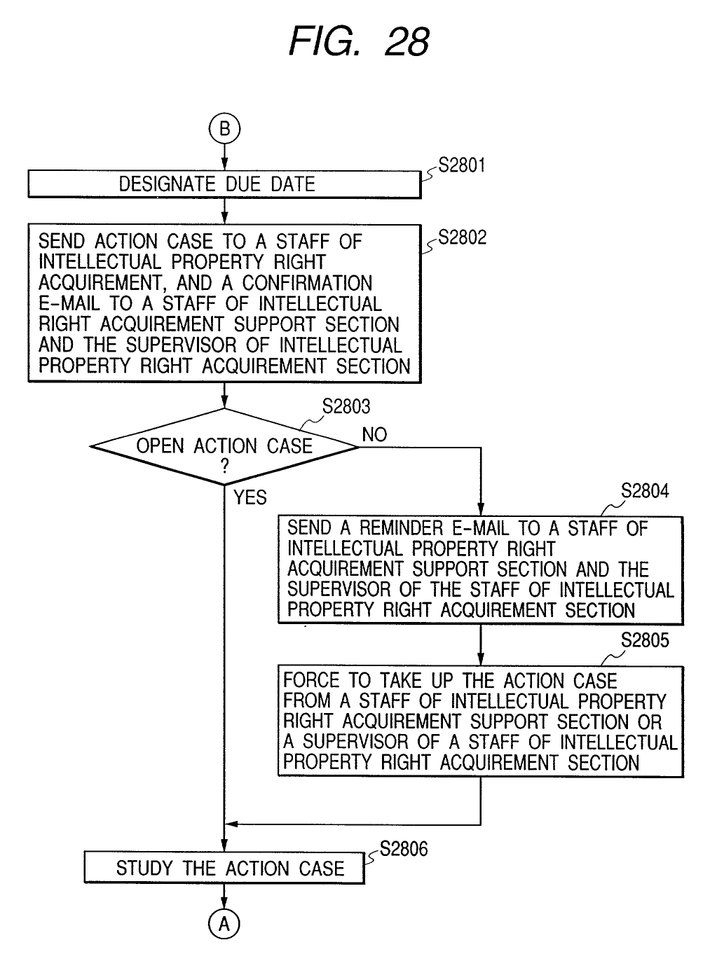

FIG. 29 shows a display screen of a client PC for explanation of a method of using a cited document database designed in the server 118;

FIG. 30 shows a display screen of a client PC for explanation of a method of using a cited document database designed in the server 118;

FIG. 31 shows a display screen of a client PC for explanation of a method of using a cited document database designed in the server 118;

FIG. 32 shows a display screen of a client PC for explanation of a method of using a cited document database designed in the server 118;

FIG. 33 shows a display screen of a client PC for explanation of a method of using a cited document database designed in the server 118;

FIG. 34 describes the definition of a DB management item in designing a database;

FIG. 35 describes the definition of a DB management item in designing a database;

FIG. 36 describes the definition of a DB management item in designing a database;

FIG. 37 shows a process performed when information is transmitted and received between a head office 107 and a Patent Office 114 through a domestic firm 112 according to a third embodiment of the present invention;

FIG. 38 is a flowchart of a process of transmitting data relating to each application case to an applicant in the domestic firm 112;

FIG. 39 is a table showing a relation of a bibliographic data for each case;

FIG. 40 shows an example of a display of a monitor of a host computer 205;

FIG. 41 shows an example of a display of a list of data by applicants;

FIG. 42 is a flowchart of a process of generating and storing data by applicants;

FIG. 43 is an explanatory view showing an information management in a network environment connecting a plurality of countries;

FIG. 44 shows an example of storage items of a management server 115 in a country B;

FIG. 45 shows an example of a document stored in a document server 114 in the country B;

FIG. 46 is a table specifying a document to be restricted in exporting information in the country B; and

FIG. 47 is a flowchart showing a determination made when a document is transmitted overseas from a server 118 of the country B.

### DETAILED DESCRIPTION OF THE PREFERRED EMBODIMENTS

(First Embodiment)

The first embodiment of the present invention is described below by referring to the attached drawings.

(Entire Configuration of Intellectual Property Management System)

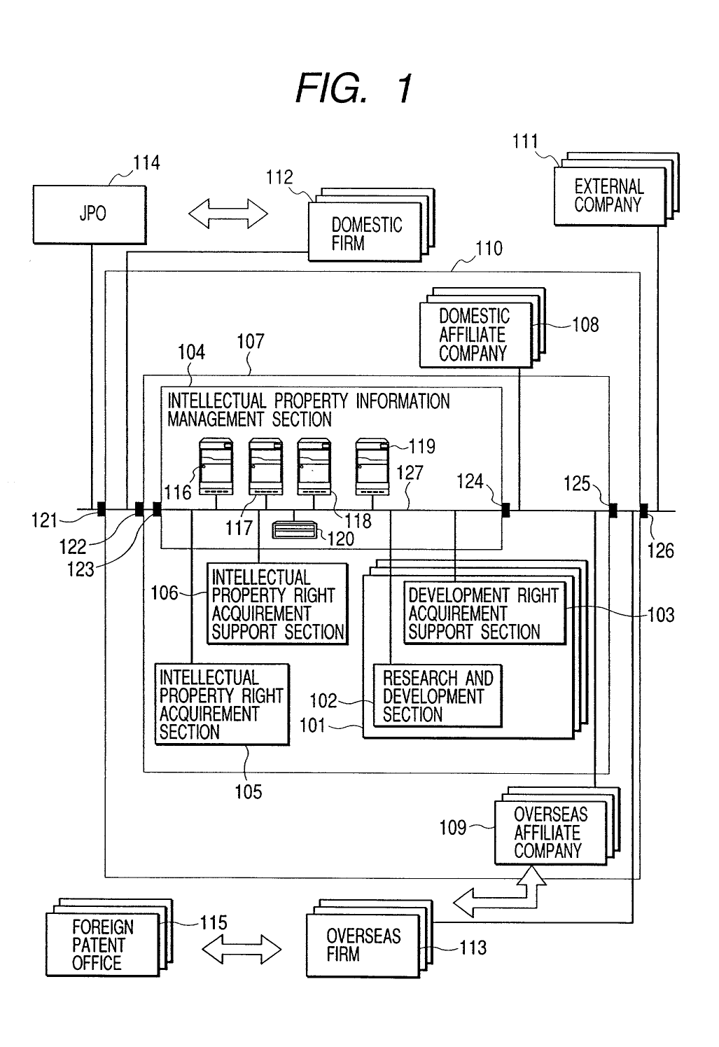

FIG. 1 shows the typical configuration of the intellectual property management system according to the present embodiment.

In FIG. 1, reference numeral 107 denotes the head office of an enterprise performing economic activities such a research, development, production, sales, etc., and includes a section for managing the intellectual property such as a patent, etc.

Reference numeral 104 denotes an intellectual property information management section including a document server 116, a management server 117, servers 118, 119, 120, etc.

The document server 116 includes a document DB (database) for management of a file wrapper, etc. containing the electronically generated documents, a series of documents generated in the communications between server 116 and Patent Office. The management server 117 contains bibliographic information such as an application number, a patent number, a filing date, a registration date, etc., and a management DB for management of the term of the office action of Patent Office. The server 118 contains a general purpose DB storing a specific publication of Japanese Patent Office, US. Patent Office, etc., and related information. The server 119 configures an application system for management of a work flow described later, and other database (for example, a database of cited documents). The server 120 integrally manages the document servers 116 to 119, and controls the entire intellectual property information management system. In the embodiment described below, a ‘system’ refers to a system managed by the server 120.

These components are all connected to a basic network 127. Each of the above mentioned components of the intellectual property information management section 104 can be realized by the same computer machine.

A document stored in the document server 116 can be normal text documents, drawings stored as normal image information, mixed mode documents containing both text and images, documents in the format unique to a word processor, etc. The electronic documents used in the communications with Patent Office and in-house documents are stored in a document database of the document server 116 by the application system of the server 119. Normally, the document database is assigned a number identifying the document, and linked to the management database of bibliographic items in the management server 117.

Reference numeral 105 denotes an intellectual property right acquirement section for acquiring the right of the intellectual property by transmitting and receiving documents directly to and from Patent Office.

Reference numeral 106 denotes an intellectual property right acquirement support section for supporting the acquirement of the right of an electronic patent application original, term management, etc.

Reference numeral 101 is a section for research and development including a research and development section 102 and a development right acquirement support section 103 for supporting the acquirement of the right of developed intellectual property.

The intellectual property right acquirement section 105 and the intellectual property right acquirement support section 106 have the routine of inputting information and generating documents about intellectual property, and can operate an exclusive application screen of a client PC in principle.

On the other hand, the research and development section 102 normally performs research and development, and incidentally performs the operations related to the intellectual property. Therefore, it accesses the servers 116 to 119 of the in-house intellectual property information management section 104 through an in-house network, displays a Web screen, and performs a necessary process. A corresponding staff can be notified of the timing of opening the Web screen through in-house electronic mail.

Reference numeral 108 denotes a plurality of domestic affiliate companies located in Japan. Reference numeral 109 denotes a plurality of overseas affiliate companies located overseas. They can communicate with each other with the security guaranteed through a dedicated line (electronic mail, facsimile communications, etc. using a specified transmission path of data on transmission and reception sides).

Reference numeral 110 denotes an enterprise group comprising the head office 107, the domestic affiliate companies 108, and the overseas affiliate companies 109.

Reference numeral 111 denotes a plurality of external companies for cooperatively perform research and development with the enterprise group 110. They manage the products of the cooperative research and development based on the mutual contract, and acquire a patent right. The system can transmit and receive data through Internet.

Reference numeral 112 denotes a plurality of domestic firms related to intellectual property located in Japan. Reference numeral 113 denotes a plurality of overseas firms related to intellectual property. They can communicate with each other through the above mentioned dedicated line or Internet.

Reference numeral 114 denotes Japanese Patent Office to which the above mentioned system is connected through an online terminal. In the present embodiment, it refers to Japanese Patent Office, but it refers to USPTO in the U.S.

Reference numeral 115 denotes a plurality of foreign patent offices with which the enterprise group 110 performs a procedure in writing through the overseas firm 113.

Each of the above mentioned sections has a plurality of terminal PCs, etc. used for inputting/outputting information or the like. A staff of each section has his or her ID and password, and can access the above mentioned system.

Each section has a plurality of client computers connected through a network, displays data of the servers 116 to 120, and prints the data of the servers 116 to 120 in a specified format on a printer. The client computer has a scanner for inputting an image as necessary.

In the present system, the amount of outgoing information is managed in plural steps. For example, between 123 and 124, that is, in the intellectual property information management section, high-level information is concentrated, and is freely distributed. Therefore, it is necessary to place a strict restriction on the outgoing information therefrom both in quantity (quantity of information) and quality (type of information).

Furthermore, between 122 and 125, that is, in the head office, the scope of the distribution of information is large. Therefore, the flow of information is limited by, for example, the prohibition of inspection outside each section so that a large amount of high-level information cannot be distributed to a specific section. Between 121 and 126, that is, in a group company, the scope of the distribution of information is enlarged. Therefore, the amount and quality of the outgoing information to each section is furthermore restricted.

On the other hand, about the security check, the level of the security check depends on the amount and quality of the distributed information, and the level of the risk of the outgoing information.

(Flow of Information in Intellectual Property Management System)

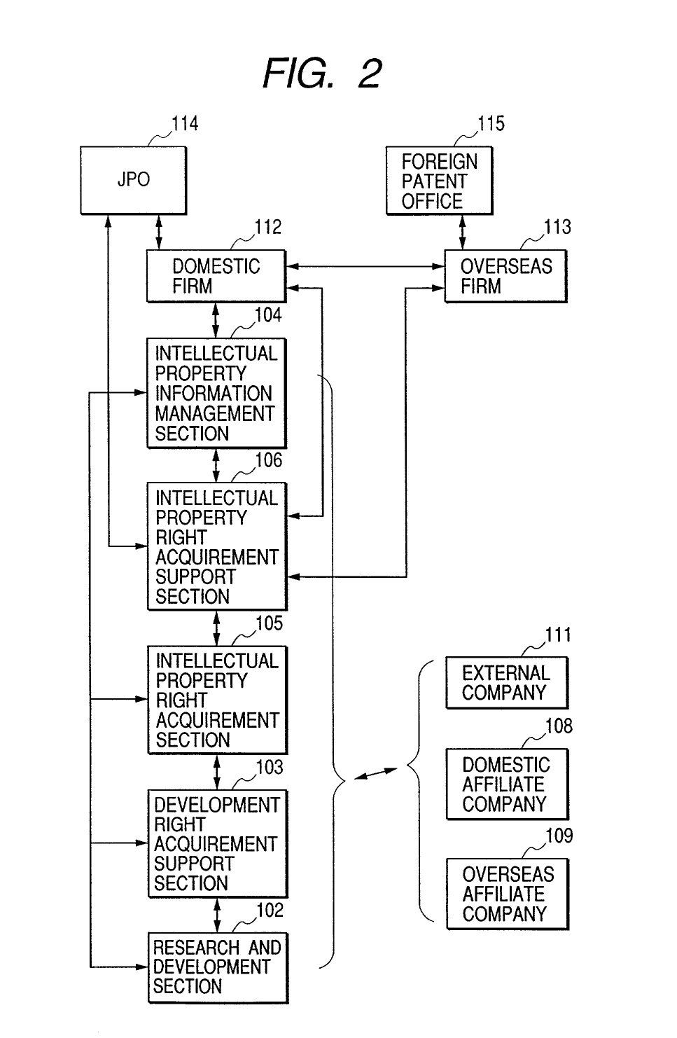

FIG. 2 shows the flow of information in the above mentioned intellectual property management system.

Documents and data are transmitted and received between the JPO 114 and the domestic firm 112 or the intellectual property right acquirement support section 106.

The overseas firm 113 communicates documents and data with the foreign patent office 115. The overseas firm 113 communicates documents and data with the domestic firm 112 or the intellectual property right acquirement support section 106. The electronic information transmitted from the overseas firm 113 is registered in the system of the intellectual property information management section 104 as necessary.

The intellectual property information management section 104 provides information for the intellectual property right acquirement support section 106, the intellectual property right acquirement section 105, the development right acquirement support section 103, and the research and development section 102 as necessary, and registers the information from each section in the system.

An external company 111, the domestic affiliate company 108, and the overseas affiliate company 109 communicates documents and data with each section in the head office 107 as necessary.

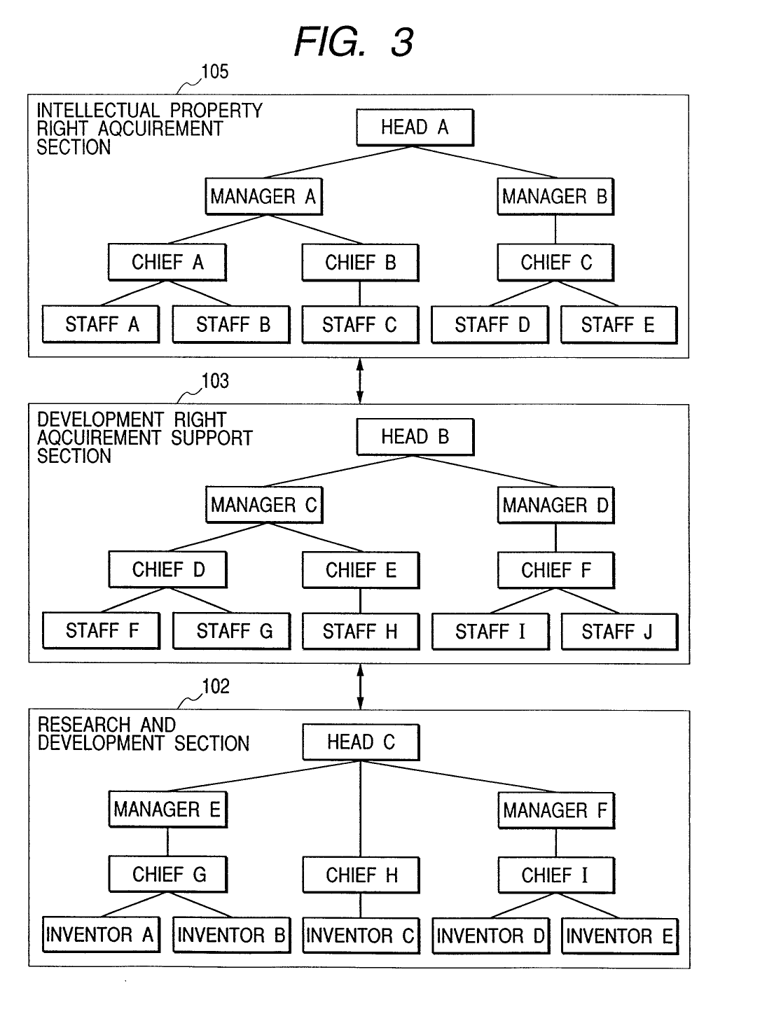

FIG. 3 shows an example of the organization of the intellectual property right acquirement section 105, the development right acquirement support section 103, and the research and development section 102.

For example, the intellectual property right acquirement section 105 has an organization in which a chief A is the boss of staffs A and B, a chief B is the boss of a staff C, a chief C is the boss of staffs D and E, a manager A is the boss of the chiefs A and B, a manager B is the boss of the chief C, and a head A is the boss of the managers A and B.

Similarly, the development right acquirement support section 103 has an organization in which a. chief D is the boss of staffs F and G, a chief E is the boss of a staff H, a chief F is the boss of staffs I and J, a manager C is the boss of the chiefs D and E, a manager D is the boss of the chief F, and a head B is the boss of the managers C and D.

Furthermore, the research and development section 102 has an organization in which a chief G is the boss of inventors (developers) A and B, a chief H is the boss of an inventor (developer) C, a chief I is the boss of inventors (developers) D and E, a manager E is the boss of a chief of the chief G, a manager F is the boss of the chief I, and a head C is the boss of the managers E and F.

In this system, the staffs of the organization is associated with the configuration of the organization, and are stored with staff codes (ID numbers of the employees) in the table of the server 119.

By storing the above mentioned organization information as a table in the system, for example, the destination of a document (mail) can be automatically set to acquire the approval of a boss, thereby checking whether there is an error in the transfer of the document addressed to a plurality of destinations in different orders. Thus, users can more easily use the functions of the system.

On the other hand, the above mentioned organization information has to be periodically updated to maintain correct information, and the maintenance is a heavy load to a user. Whether or not such organization information is to be stored in the system can be determined, for example, by each section. It is desired that the information is stored in the system for a section in which there is a small change in the information, and for a section in which the system is allowed to be more easily used by updating the information each time a change is made with the load of the maintenance taken into account.

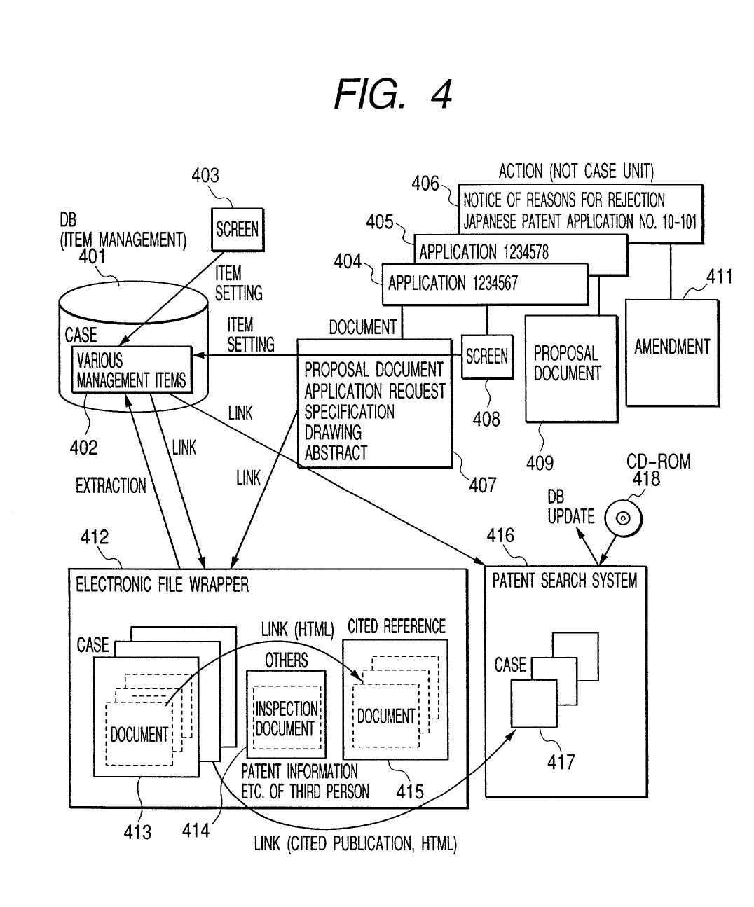

FIG. 4 shows the method for managing a database according to the present embodiment.

In FIG. 4, reference numeral 401 denotes a management DB contained in the management server 117. In this DB, various management items 402 are stored in case (application) units. A management item can be set by a staff of the intellectual property information management section on a screen 403 of the client PC.

Reference numerals 404 to 406 denote units of generating a document about each case. The unit is referred to as an ‘action’ in the present embodiment. In generating a document, a virtual file case in the system is defined as an ‘action case’.

For example, documents 407 such as a proposal document, an application request, a specification, drawings, an abstract, etc. are generated for an in-house suggestion on an invention for the action 404 which refers to the application of the management number 1234567. On a screen 408 of the client PC, the management data incident to the application such as a filing date, an inventor, etc. are confirmed. The documents 407 are registered in an electronic file wrapper 412 described later formed in the document server 116, and the management data for the latter is registered in the management DB 401 corresponding to the management item 402.

When a user (a developer, a staff) requests to display the action case, the management DB 401 is accessed for a management item. The documents 407 can be displayed by a link to the electronic file wrapper 412.

Since an application document has not been generated for an action 405 of the application of the management number 12345678, only a proposal document 409 has been registered in the system.

An amendment 411 has been registered for the action 406, that is, a notice of reasons for rejection, for the Japanese Patent Application No. 10-101.

Other actions can be processes for legal procedures such as a decision of final rejection, a declinement of amendment, a lodgement of opposition, a request for examination, a response for invitation for correction, etc.

Furthermore, the contents of the electronic file wrapper 412 formed in the document server 116 can be a document 413 for each case, an inspection document 414 such as the patent information of third parties, a cited document 415 referenced in an examination by Patent Office for a case. However, the cited document 415 can be stored in a DB on another server 119 as described above, and can be easily retrieved on the screen for access to the case through the link of the HTML.

A link is established from the management DB 401 to the electronic file wrapper 412, and necessary data can be extracted from a document registered in the electronic file wrapper 412, and then be registered in the management DB 401. A link is established from the management DB 401 and the electronic file wrapper 412 to a patent search system 416 formed by the server 118 such that a case 417 in the patent search system 416 can be easily accessed from a document in the electronic file wrapper 412.

The information in the patent search system 416 can be DB-updated through a medium 418 such as CD-ROM, etc.

(Action Case)

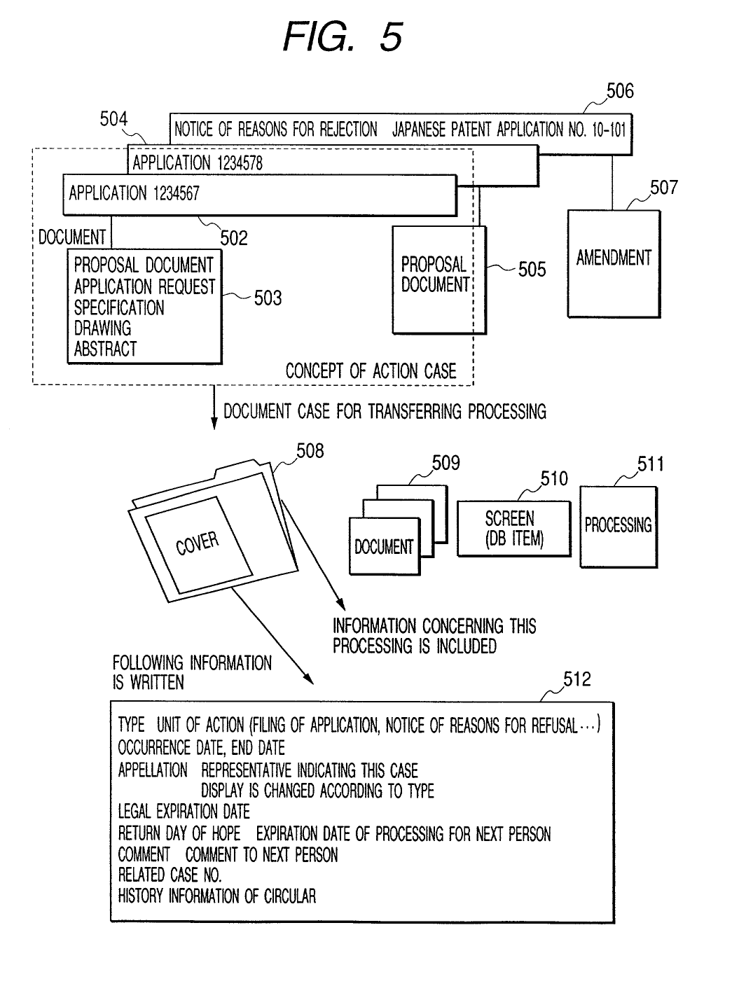

FIG. 5 shows the concept of the above mentioned action case.

In FIG. 5, reference numeral 501 denotes an action case, and contents 502 and 503 of the action case respectively correspond to the application action 404 and the document 407. Reference numerals 504, 505, 506, and 507 respectively correspond to 405, 409, 406, and 411.

As described above, the action case is a virtual file in the system indicated by 508, and contains a cover 512 describing the type indicating the unit of an action such as an application, rejection reason, as a description item, an occurrence date and an end date of the action, the appellation of an action case (the representative appellation of the case when a series of actions have a plurality of documents), a legal expiration date, a requested return date of an action case (an expiration date of processing for the next person), the comment to the next person, a related case number, the history information about the circulation of an action case (through whom the case has reached the user), etc. Necessary document 509 for the process, and a DB item 510 to be input on the screen (displayed) are inserted. Furthermore, when an amendment has been generated, a process result 511 is inserted by a person who has performed the process. The process result 511 can be completely inserted by a person who has received an action case uploading the process contents to the system, and registering them in the electronic file wrapper 412.

The concept of an action case can be varied. For example, it can be delimited in shorter units. For example, it can be delimited in generating a proposal document, checking a draft, etc. Furthermore, a plurality of submission documents to Patent Office can be collectively moved and processed as one action case.

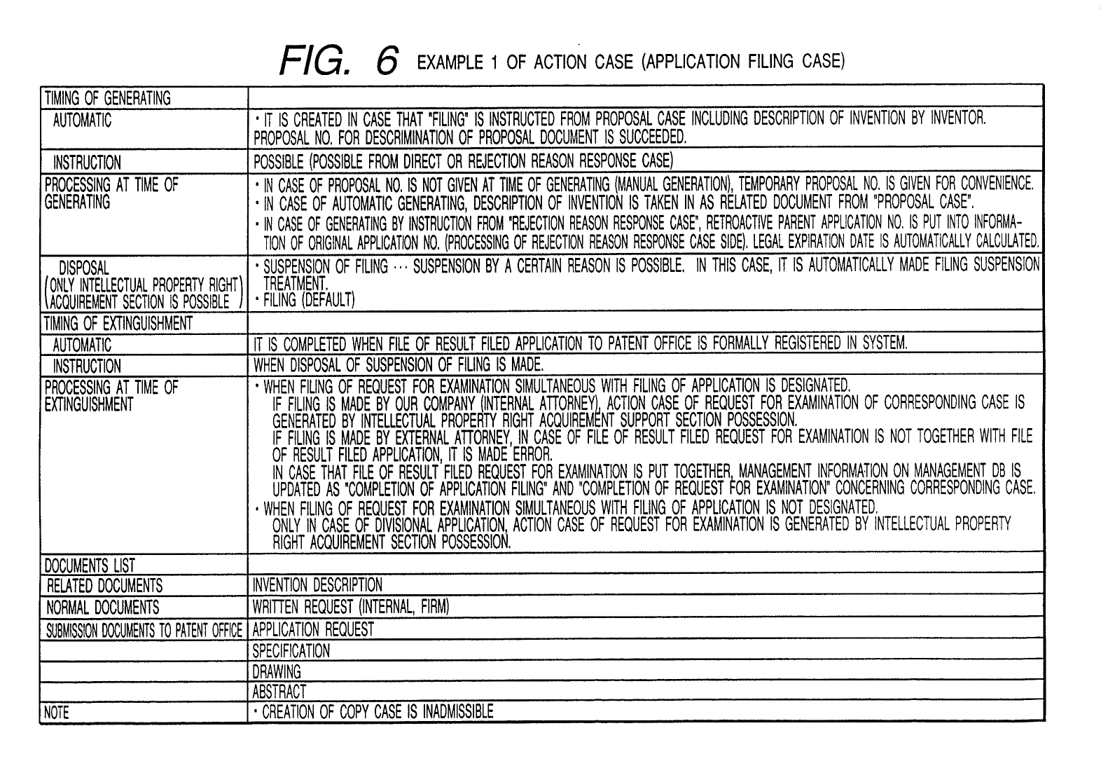

FIGS. 6 through 8 show examples of action cases.

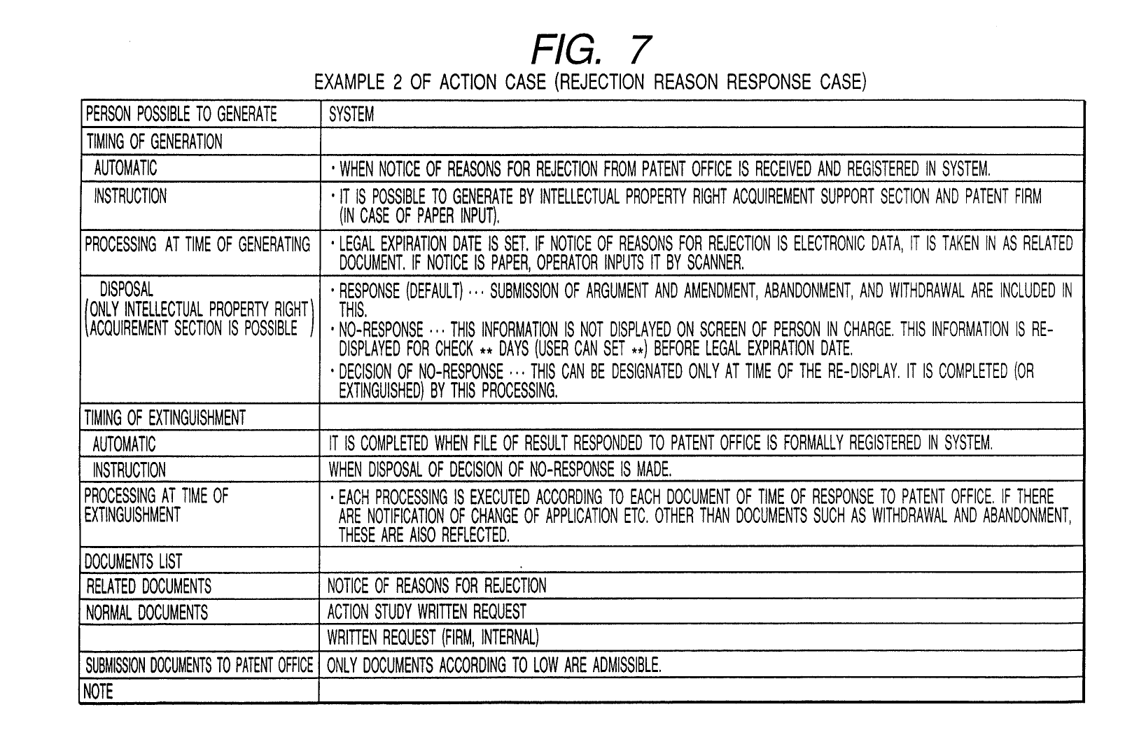

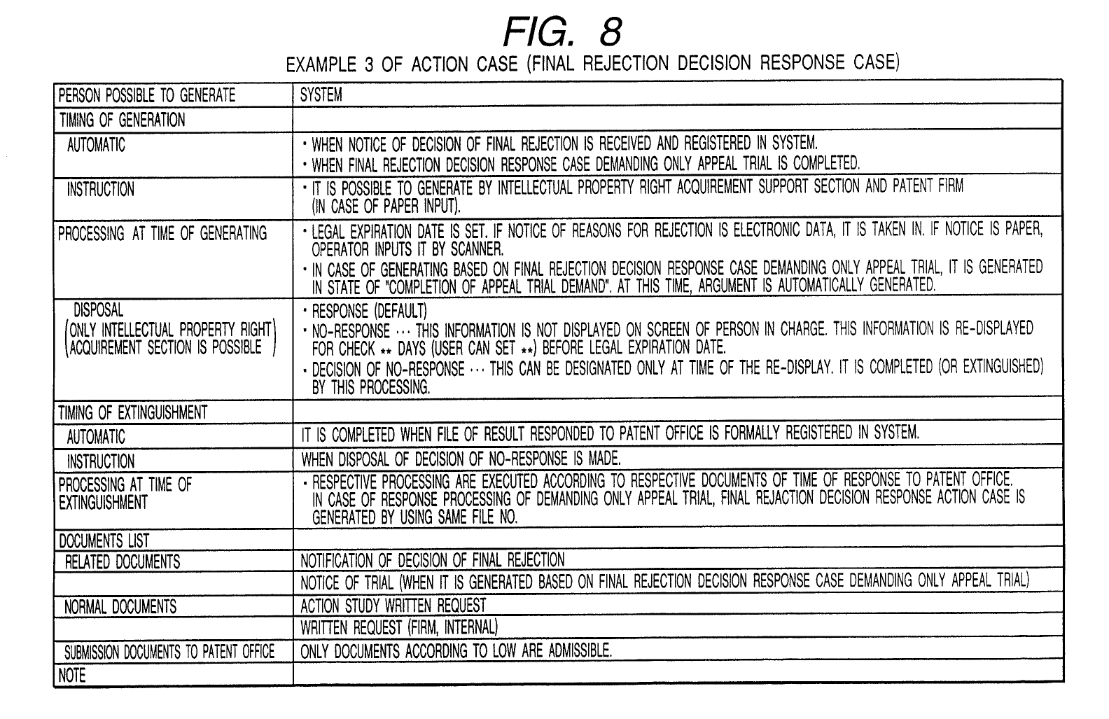

FIG. 6 shows an application case of generating an application document. FIG. 7 shows a rejection reason response case in response to a rejection reason. FIG. 8 shows a final rejection decision response case in response to a final rejection. The final rejection decision response case corresponds to JP and EP, but corresponds to an appeal in the US.

In each action, the timing of the occurrence of an action case, the process performed at the occurrence, the timing of extinguishment, the process for the extinguishment, the documents related to the process, etc. are defined. Other actions such as a request for examination, etc. can also be defined in the same manner.

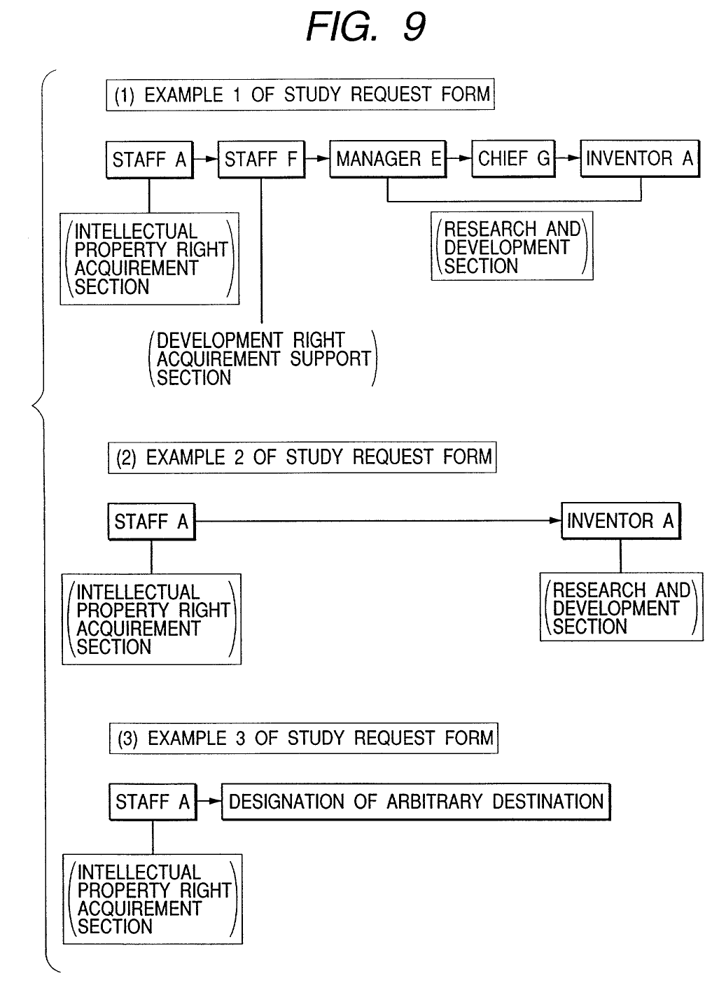

FIG. 9 shows an example of a study path of an action with the organization configuration as shown in FIG. 3.

For example, (1) refers to an example 1 of the study request form, and shows the path through which an action case is transferred from the staff A to the inventor A through the staff F, the manager E, and the chief G. For example, the study of a rejection reason corresponds to this pattern. (2) refers to an example 2 of the study request form, and shows the transfer of an action case from the staff A directly to the inventor A. For example, a check of an application original corresponds to this pattern. (3) refers to an example 3 of a study request form, and shows the case in which the staff A sequentially specifies an arbitrary destination for transfer of an action case to a studying person.

In (1) and (2) above, the system manages the work flow to automatically transferring the case. On the other hand, in (3) above, a person receiving the case transfers the case to a target person at his or her own discretion according to the in-house rule. From the viewpoint of the automation of a process, the former excels, but has the demerit that it cannot flexibly perform a process in an organization. According to the present embodiment, the system supports both, thereby flexibly operating the system depending on the type and situation the type of action and section.

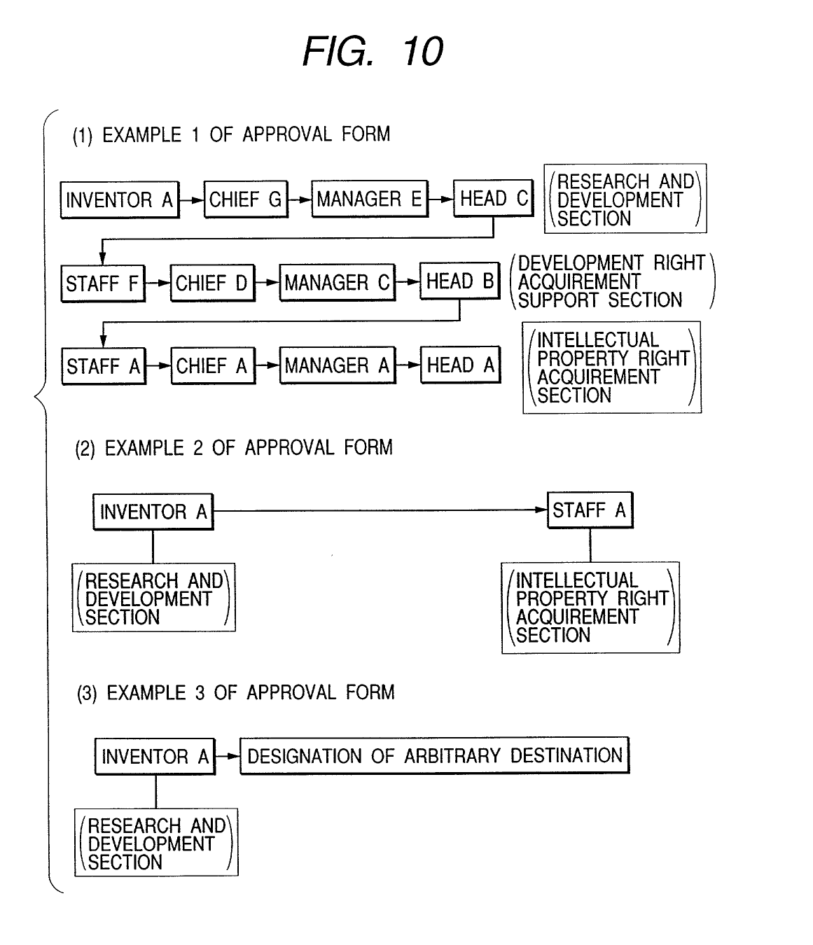

Similarly, FIG. 10 shows an example of the path of the approval of an action study result.

For example, (1) is the example 1 of an approval form, and shows the path of the transfer of an action case from the inventor A to the head A through the chief G, the manager E, the head C, the staff F, the chief D, the manager C, the head B, the staff A, the chief A, and the manager A. For example, approving and accepting an invention proposal document correspond to this pattern. (2) is the example 2 of an approval form, and shows the path of the transfer of an action case from the inventor A directly to the staff A. For example, checking an application original, answering in an urgency, etc. correspond to this pattern. (3) is the example 3 of a study request form, and shows the case in which an action case is transferred from the inventor A to the final person for approval with arbitrary destinations sequentially specified.

In the case of approval, the form of (3) is provided for the same reason as in the above mentioned study request.

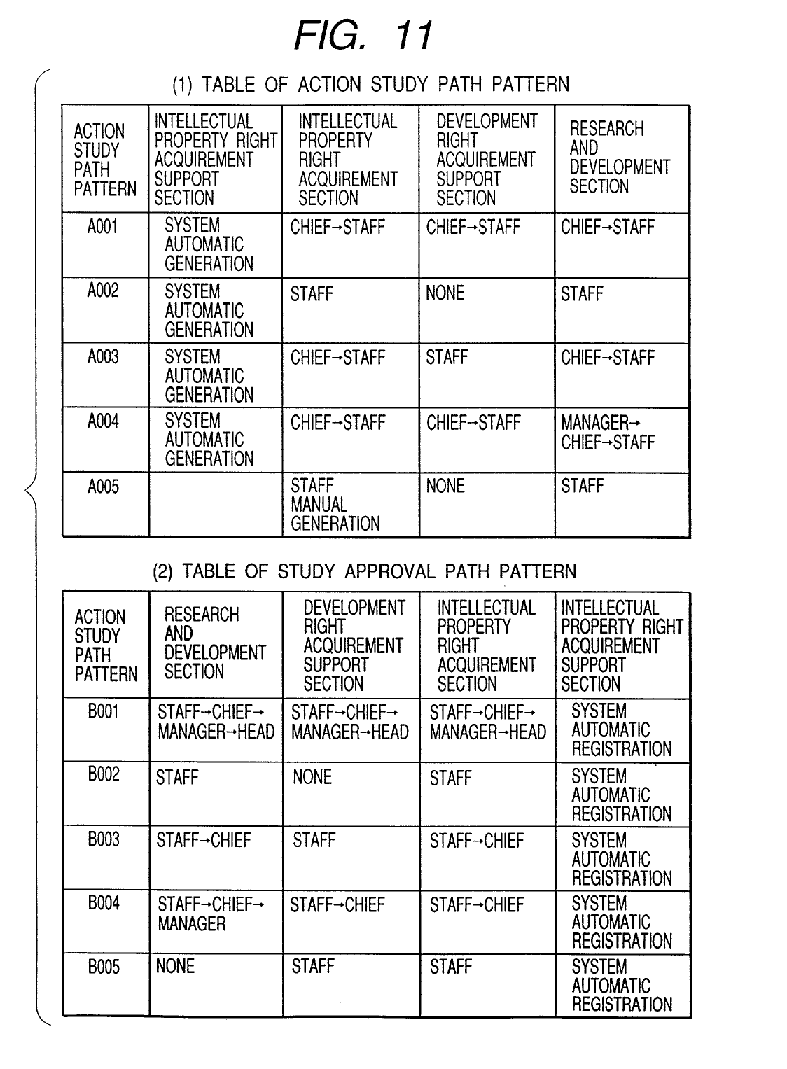

FIG. 11 shows a table of a path pattern of the study and the approval of an action shown in FIGS. 9 and 10. (1) shows a study path pattern, and describes the patterns from A001 to A005 as examples. For example, A001 is a pattern in which an action case is automatically generated by the system, and is transferred from a chief of the intellectual property right acquirement section to a staff, from a chief of the development right acquirement support section to a staff, and from a chief of the research and development section to a staff. (2) shows a study result approval path pattern, and describes the patterns from B001 to B005 as examples. For example, in B002, the system automatically registers a study result after an action case is transferred from a staff in the research and development section to a staff in the intellectual property right acquirement section.

These path patterns are registered in the server 119 so that the work flow management can be smoothly controlled. Furthermore, by setting the path pattern as a table, the work flow of an action case can be easily changed only by changing the table. In this table, patterns of destination-designated arbitrary path can be defined as A000 and B000.

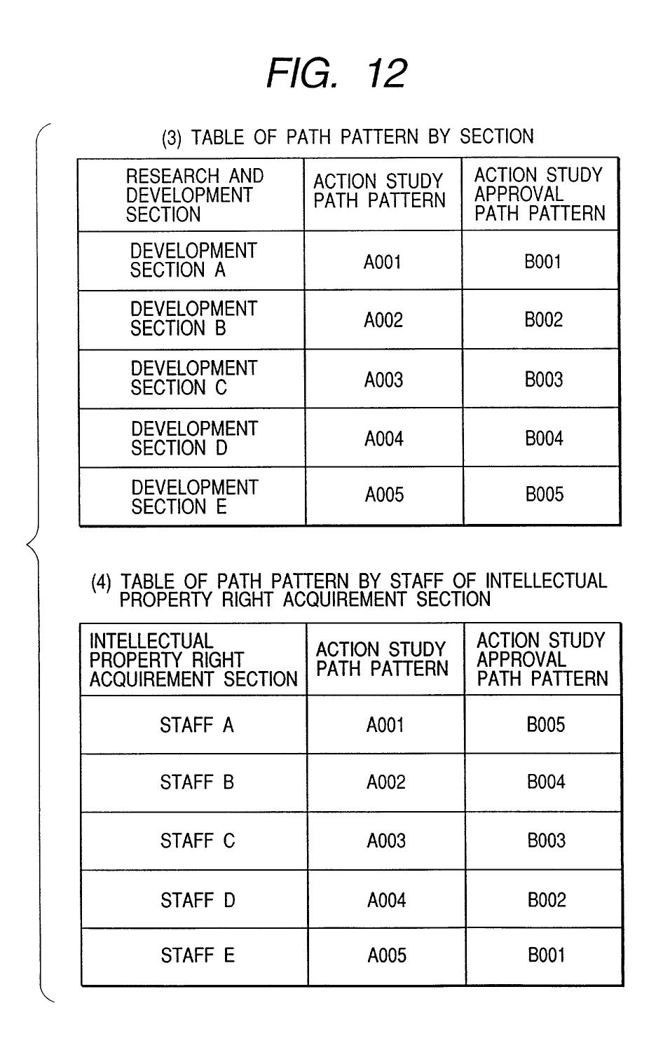

FIG. 12 is a pattern selection table for free assembly of a work flow by section (3), and by staff of the intellectual property right acquirement section (4) by using pattern tables shown in FIG. 11.

For example, the development section A selects A001 as a action study path pattern, and selects B001 as a study approval path pattern. Otherwise, the staff A selects A001 as an action study path pattern, and B005 as a study approval path pattern. Using the pattern selection table, the customization by section or by staff can be realized. In addition, a pattern table or a selection table can be used for each type of action case.

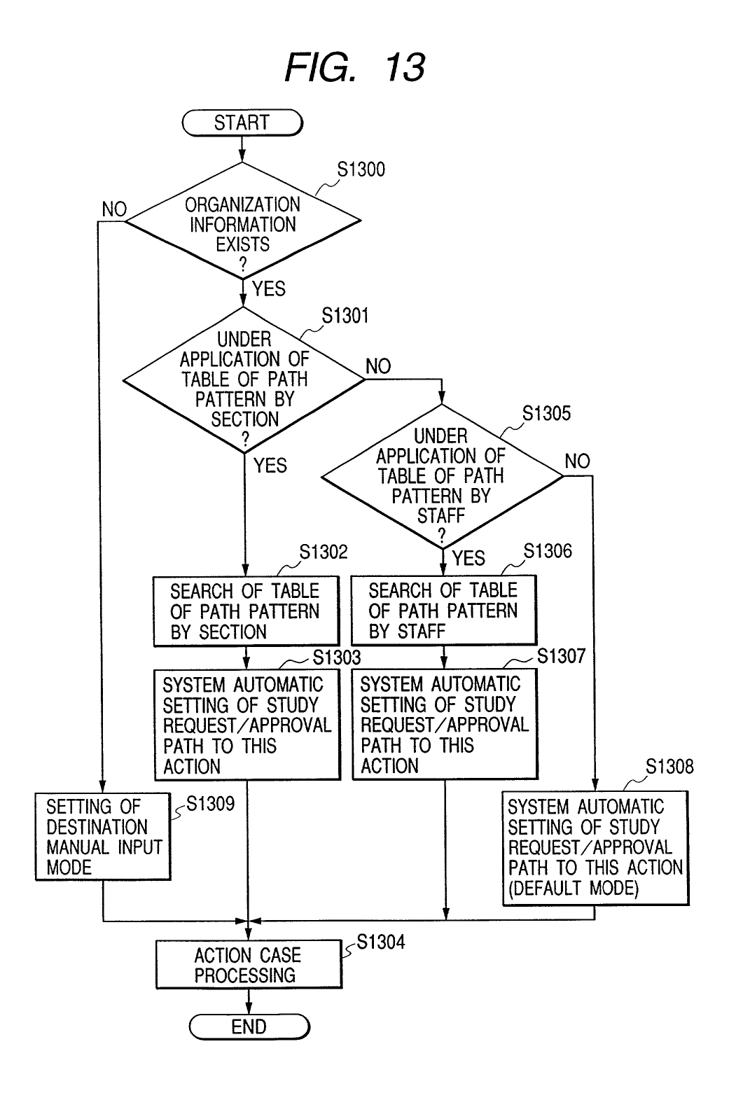

FIG. 13 is a flowchart of setting a flow of an action case.

First, it is determined in S1300 whether or not the organization information shown in FIG. 3 has been registered in the system, and it is determined in S1301 whether or not it is set such that the table of path pattern by section shown in FIG. 12(3) can be applied. When it is applied, the table of path pattern by section is searched in S1302, the system automatically sets a study request and approval path for the action case in S1303, and an action case process is performed in S1304.

On the other hand, when the table of path pattern by section is not applied (NO in S1301), it is determined in S1305 whether or not it is set such that the table of path pattern by staff in the intellectual property right acquirement section can be set. If YES, the table of path pattern by staff is searched in S1306, the system automatically sets a study request and an approval path for the action case in S1307, and an actual action case process is performed in S1304.

On the other hand, when the table of path pattern by staff is not applied (NO in S1305), the system automatically sets a predetermined default mode for the study request and approval path for the action case in S1308.

When there is no organization information (NO in S1200), a mode in which a destination is manually input is set in S1309.

As described above, by combining the organization information with a path table and a selection table, the transfer of an action case can be efficiently managed.

(Document Follow-up Function of Action Case)

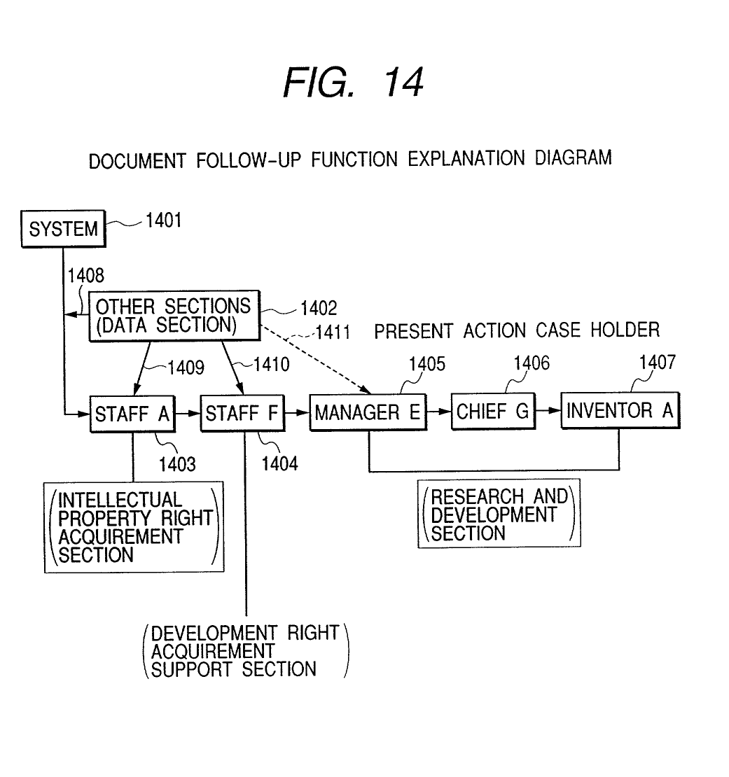

FIG. 14 shows the document follow-up function of a document to be stored in an action case.

In this example, a study request for an action case automatically generated by a system 1401 is transferred in the order of the staff A (1403), the staff F (1404), the manager E (1405), the chief G (1406), and the inventor A (1407). In this case, if an action case is maintained in the system until the cited document is obtained when the system 1401 generates an action case, and when it takes some time for a user to obtain a part of the cited documents described in the notice of reasons for rejection, then time required for actual study is wasted, thereby causing low efficiency.

On the other hand, until an action is transferred to a person who actually studies a response to a notice of reasons for rejection, it is often possible to appropriately determine without a part of cited documents the process of determining a person who studies a response, etc.

Then, according to the present embodiment, in this case, when the circulation is started with a part of documents not yet obtained for an action case, and necessary documents are obtained later, the system 1401 additionally inserts the documents obtained from other sections 1402 such as a material section, etc. to the case of the holder of the action case as follow-up, and the mail for informing that the documents (document follow-up material) have been inserted is transmitted to a person who has already passed the action case.

The follow-up document can be transmitted from a section (person) which is not a section (person) generating the original study request as described above, or can be transmitted from the same section (person).

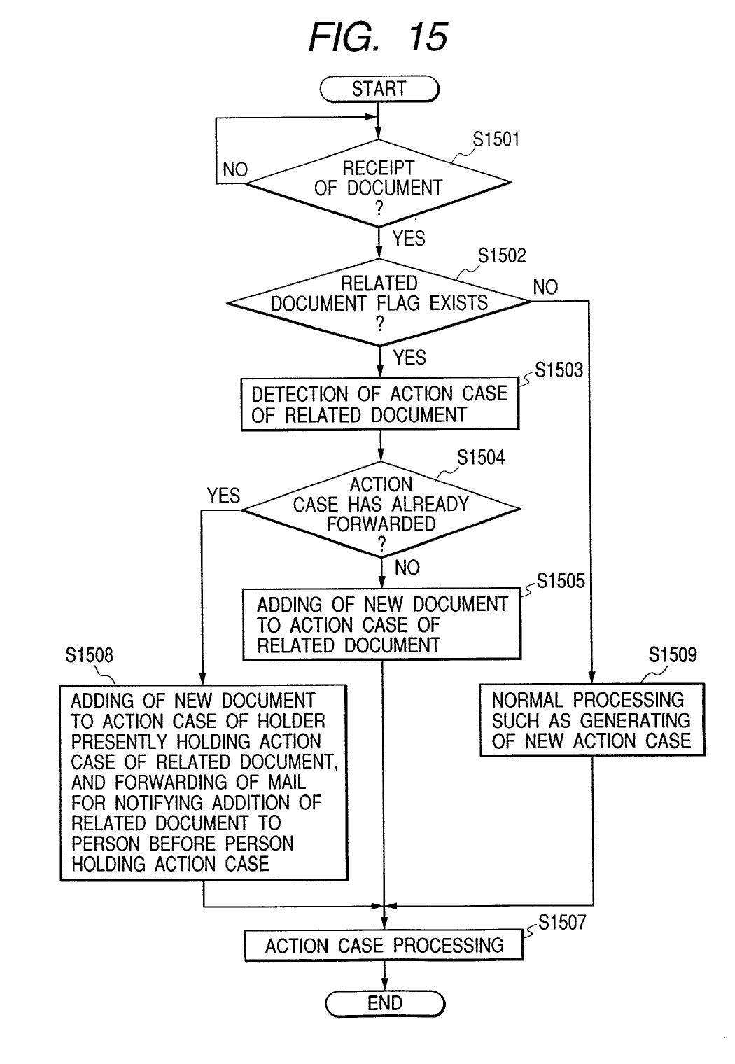

FIG. 15 is a flowchart of the document follow-up process.

First, when the system receives a document in S1501, it is determined in S1502 whether or not the document is provided with a flag of a related document (identification code for identifying a related document). If a related document flag is provided, the action case of the related documents is detected in S1503. Then, in S1504, it is determined whether or not the action case has been transmitted and is beyond the control of the system. If NOT, a newly received document is added to the action case of the related documents in S1505, and is transmitted, and control is passed to the process of the action case in S1507.

On the other hand, if the action case has been transmitted (YES in S1504), a new document is added to the action case of a person who currently holds the action case of the related documents, and notification mail about the added document is transmitted to a person preceding the person holding the above mentioned action case, that is, a person already described in the circulation history. The person who has received the mail can be inspected in the system of the newly added document. The document to be added can be attached to the mail, or the mail can be accessed by describing the address in the DB of the added document. In this case, a person who has already passed an action case cannot register a document such as an amendment, etc. to the action case. However, if it is necessary to perform an important process on the action case, a necessary document can be registered when the action case is returned or a check result is returned.

If there is no flags of related documents (NO in S1502), a normal process such as generating a new action case, etc. is performed in S1509.

By the above mentioned document follow-up function, the studying process can be efficiently performed by effectively using the limited studying time. The above mentioned document follow-up function is not limited to the above mentioned study of the action (a notice of reasons for rejection, etc.) of a patent, but can be applied to any study performed by a plurality of staffs who study anything through a network, thereby performing efficiently study through a network.

(Function of Copying Action Case)

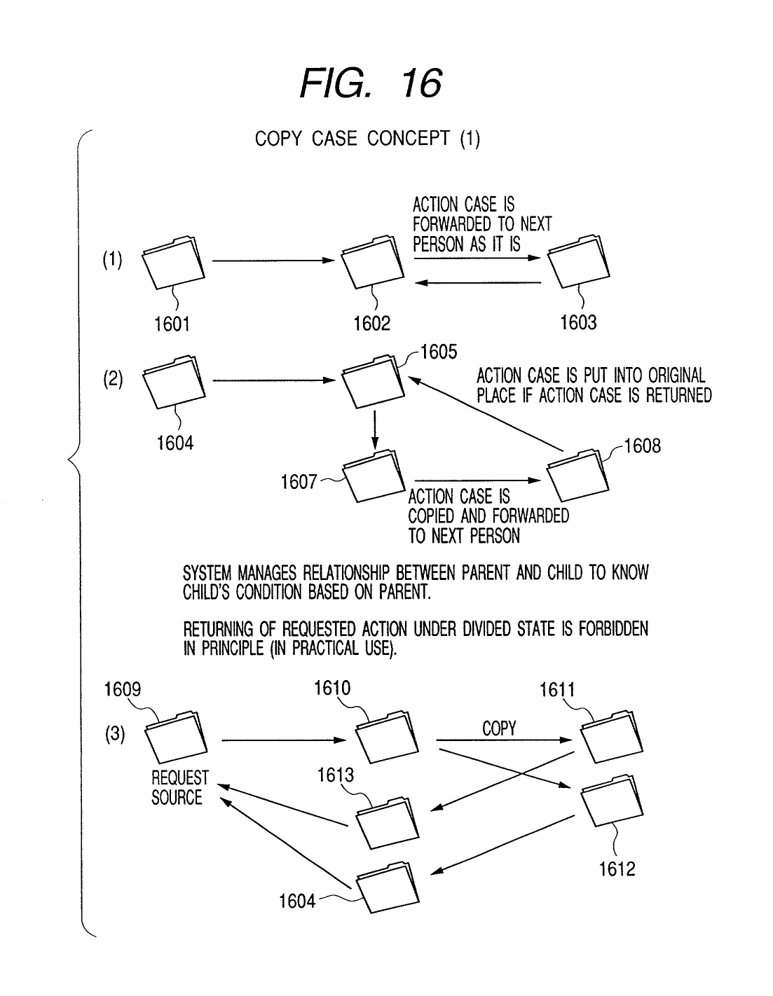

FIG. 16 shows the function of copying an action case.

In a method of using the above mentioned action case, typically a person who has received the action case 1601 assigns the number 1602 to the case and pass it to the next person as 1603 as it is as shown in FIG. 16-1.

On the other hand, as shown in (2) of FIG. 16, a person who has received an action case 1604 processes it as 1605 by himself or herself, and may also request the next person to study it simultaneously. In this case, in the system according to the present embodiment, the person generates a copy case 1607 of the action case 1605, holds the action case 1605, and can have another person study the copy case 1607. However, in principle in this case, the person who has generated the copy case can integrate a case 1608 which has been copied and returned. That is, dividing a requested action case and returning it to the originating person is prohibited in principle.

A use form of a copy case is not limited to the above mentioned example. That is, as shown in 3, the holder of 1610 copies a case 1609 received from a requester, divides it into 1611 and 1612, and can pass them for parallel study. However, returned 1613 and 1614 are not returned as separate cases to the requester, but the person who made copies integrates and returns them to the requester.

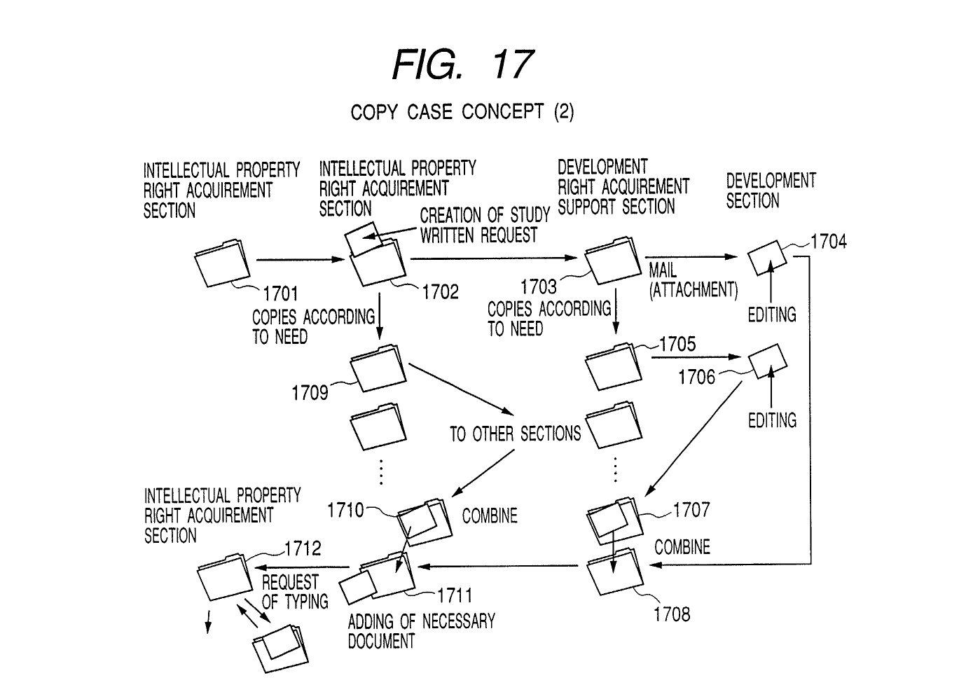

FIG. 17 practically shows the method of using a copy case.

An action case 1701 from the intellectual property right acquirement support section 106 is transmitted with a written study request generated in the intellectual property right acquirement section 105 to the development right acquirement support section 103 as 1702, and a copy case 1709 is generated and transmitted to other sections.

The development right acquirement support section 103 transmits a written study request of a case 1703 as an attached document of electronic mail to the research and development section 102, on the other hand, generates a copy case, and transmits a written study request of a copy case 1705 as an attached document of electronic mail to another development section.

The research and development section 102 edits study results 1704 and 1706, and returns them as 1707 and 1708 respectively to the development right acquirement support section 103. Then, they are combined and integrated, and returned to the requester, that is, the intellectual property right acquirement section 105. In this example, a study result 1710 corresponding to the study request which has been passed to another section for study is combined and integrated with 1711, a necessary document is generated and added, and 1712 is passed to the intellectual property right acquirement support section 106 for a typing request process, etc.

By using the above mentioned function of copying an action case, a plurality of staffs can efficiently study a requested item within a short time.

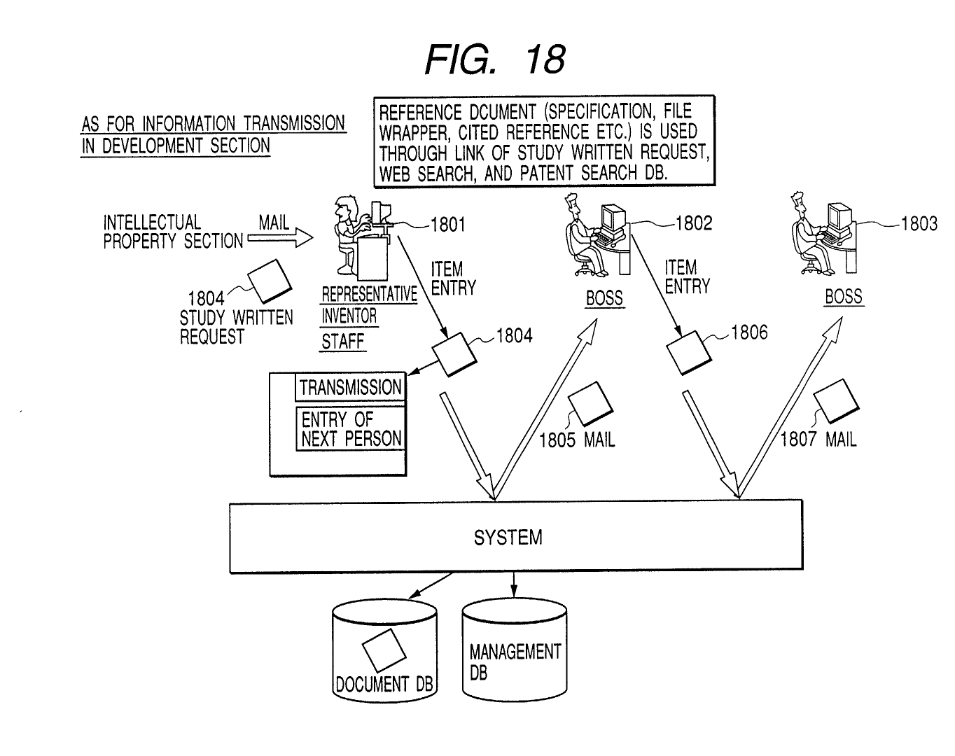

FIG. 18 shows an example (a case in which a studying person sequentially specifies the next studying person) of a method of transmitting information in the research and development section 102.

When a written study request 1804 is transmitted by mail from the intellectual property right acquirement section (105, 106, or 103), a representative inventor and a staff 1801 enter a necessary study item and the next studying person in the document 1804 on their PCs, and input a transmission instruction using a transmission button embedded as a macro on the document. Using the transmission button, the document 1804 is registered in the system, stored in the document server 116, and mail 1805 is transmitted to the next studying person (approver). Then, a next boss 1802 enters an item on a document 1806 similarly, registers it in the system, and transmits mail 1807 to a boss 1803.

The above mentioned work flow is managed by the system, and the studying person input the next studying person (approver), pushes the transmission button, thereby performing the system registration and mail transmission.

(Invoice Process)

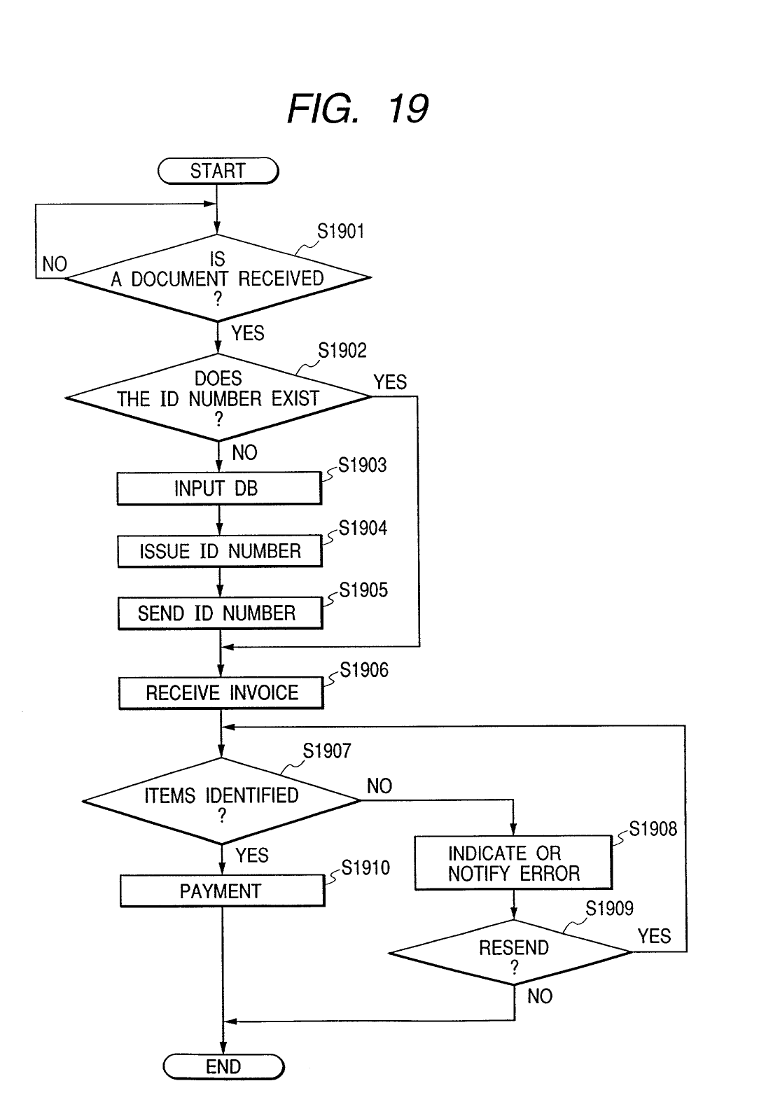

FIG. 19 is a flowchart of the invoice process from an intellectual property related firm in the present system.

In FIG. 19, when a document (for example, a notice of reasons for rejection, drafts of an argument and an amendment, an application original, a foreign application original, etc.) from an organization other than Patent Office (for example, an attorney's office, a translator's office, etc. which are hereinafter referred to as an intellectual property related firm) in S1901, it is confirmed in S1902 whether or not an ID number at the time of request for a service (for example, an ID number assigned when a request is issued to an attorney's office, etc.) has been added. If an ID number has been assigned, control is passed to S1906. If it has not been assigned, then a document is input to the DB in S1903, an ID number is issued in S1904, and the ID number is transmitted to the intellectual property related office in S1905.

In S1906, an invoice is received, and the ID number and the item (type, etc.) of the document are confirmed. For example, if the contents of the invoice refer to an item of a rejection reason notice response for the ID number about the item of a request for preparing an application original, it is an error. Furthermore, if an invoice of an amount equal to or larger than a predetermined value set in the system in advance has been issued, then it is displayed on the in-house client PC, and an error notification is manually issued unless non-error can be confirmed offline (for example, by phone, facsimile, etc.).

If an item and an ID number matches in S1907, then a payment is made in S1910. If they do not match, an error notification is displayed in S1908, and it is reported to an intellectual property related office. Then, it is confirmed in S1909 whether or not the invoice is to be re-transmitted.

As described above, an ID is assigned to a requested service, and is compared with the contents when the service is provided, thereby easily linking the contents of the service to the invoice in the system.

(Second Embodiment)

(Entire Configuration of Intellectual Property Management System)

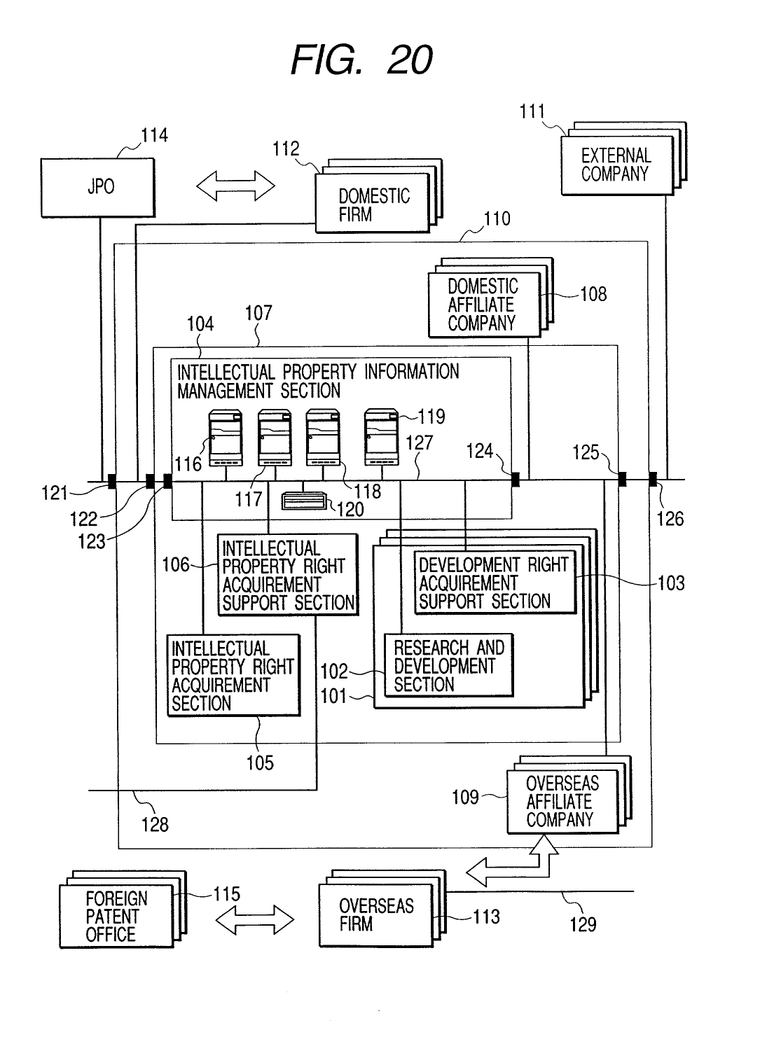

FIG. 20 shows the typical configuration of the intellectual property management system according to the second embodiment of the present invention.

The basic configuration and function are the same as in FIG. 1. The system shown in FIG. 1 is basically operated online through networks regardless of domestic or foreign use, but the present embodiment is different from the first embodiment in the following points.

Reference numerals 128 and 129 denote public lines through which facsimile data can be communicated. Each of the intellectual property right acquirement support section 106, the overseas firm 113, the domestic firm 112, etc. comprises at least one facsimile device.

The ideal form of the entire system is the totally online system as in the first embodiment as described above. However, there can arise an environment in which electronic mail and Web temporarily cannot be used.

Therefore, according to the present embodiment, a paper medium and facsimile communications are used as ancillary communications means.

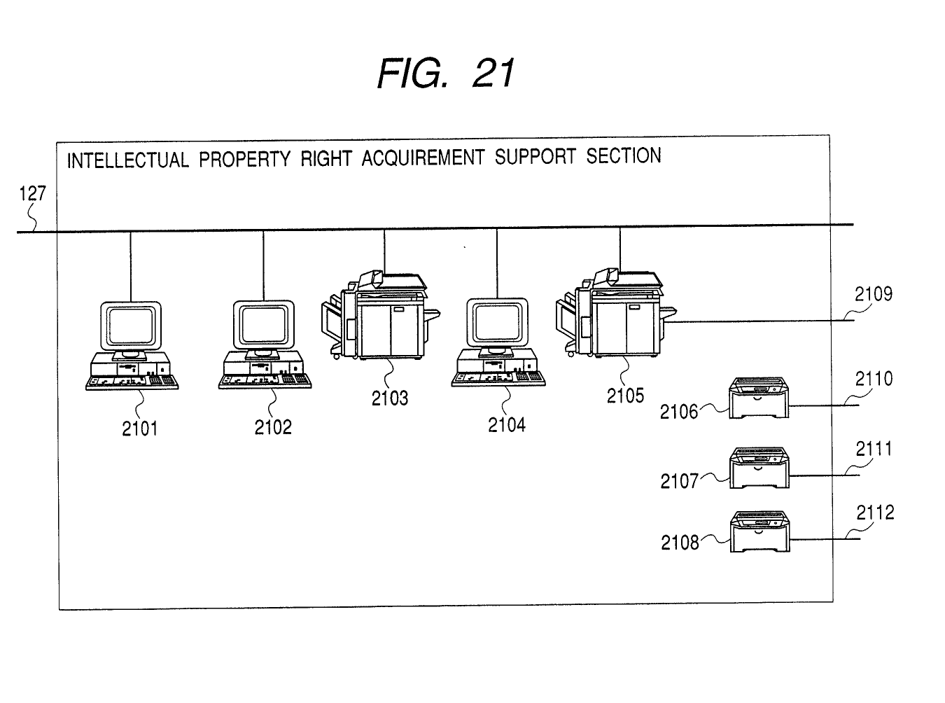

FIG. 21 shows an example of an OA appliance provided in the intellectual property right acquirement support section 106.

Clients 2101, 2102, and 2104, a high-speed scanner printer 2103, and a high-speed scanner-printer-facsimile compound machine 2105 are connected to the basic network 127. In addition, the PC 2102 has the function of the server of the scanner printer 2103, and the PC 2104 has the function of the server of the compound machine 2105. Reference numeral 2109 denotes an analog or digital public line, and is used by the compound machine 2105 for transmission and reception of facsimile data. Reference numerals 2106, 2107, and 2108 denote stand-alone facsimile devices, and perform facsimile communications through public lines 2110, 2111, and 2112 respectively.

The intellectual property right acquirement support section 106 communicates information by facsimile with external firms such as the overseas firm 113, the domestic firm 112, etc.

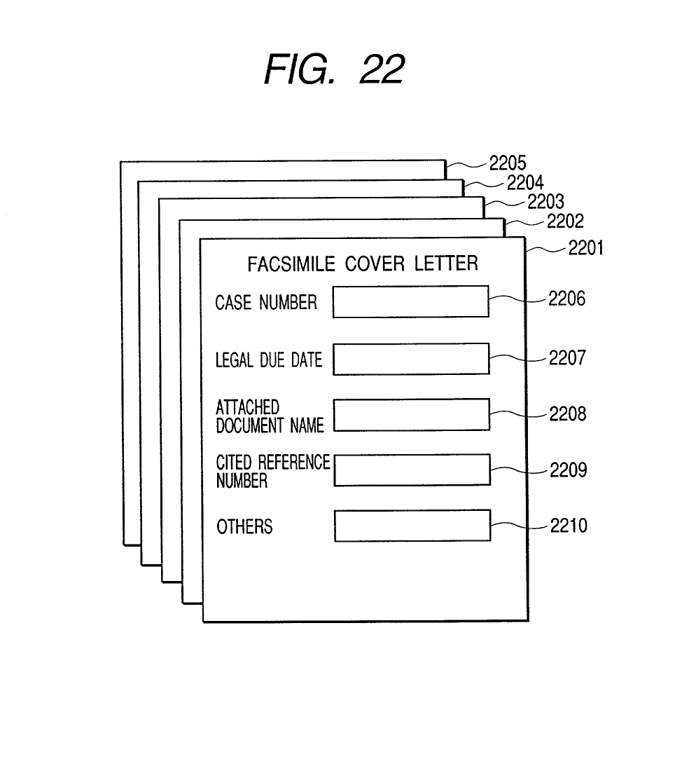

At this time, in an urgency (when the term of an answer comes soon, etc.), a transmitter performs facsimile communications to the urgency exclusive line 2109 in a plurality of lines, and uses a sheet as shown in FIG. 22 as a cover page of the facsimile communications.

In FIG. 22, a cover sheet 2201 describes a case number and its OCR bar code 2206, a legal due date and its OCR bar code 2207, an attached document name and its OCR bar code 2208, a cited reference number and its OCR bar code 2209, and other bibliographic information and its OCR bar code 2210, and is read on the transmission side. Reference numeral 2202 denotes, for example, an office action (notice of reasons for rejection), reference numeral 2203 denotes the first cited document, reference numeral 2204 denotes the second cited document, and reference numeral 2205 denotes the third cited document.

Thus, by receiving the bibliographic information with the OCR code on the front page, a server 2104 recognizes process information from the facsimile data fetched through a compound machine 2105, and electronic data about bibliographic information can be provided for the system. In addition, the office action 2202, and the cited document 2203 to 2205 can also be fetched as facsimile data (electronic data) to the system.

The bibliographic information extracted from the front page 2201 is registered in the management server 117, and the above mentioned action cases are automatically generated by the server 119 depending on the legal due date and the specified due date of an answer to an office. On the other hand, the facsimile data of 2202 to 2205 is registered in the document server 116. The facsimile data can be transmitted in the G3 system or the G4 system, and also can be compressed data such as JBIG, etc. Especially, in the system in which facsimile data can be directly fetched to a database as in the system according to the present embodiment, the data in the hierarchical coding system as the JBIG is effective when a user uses the data after inputting it in a database.

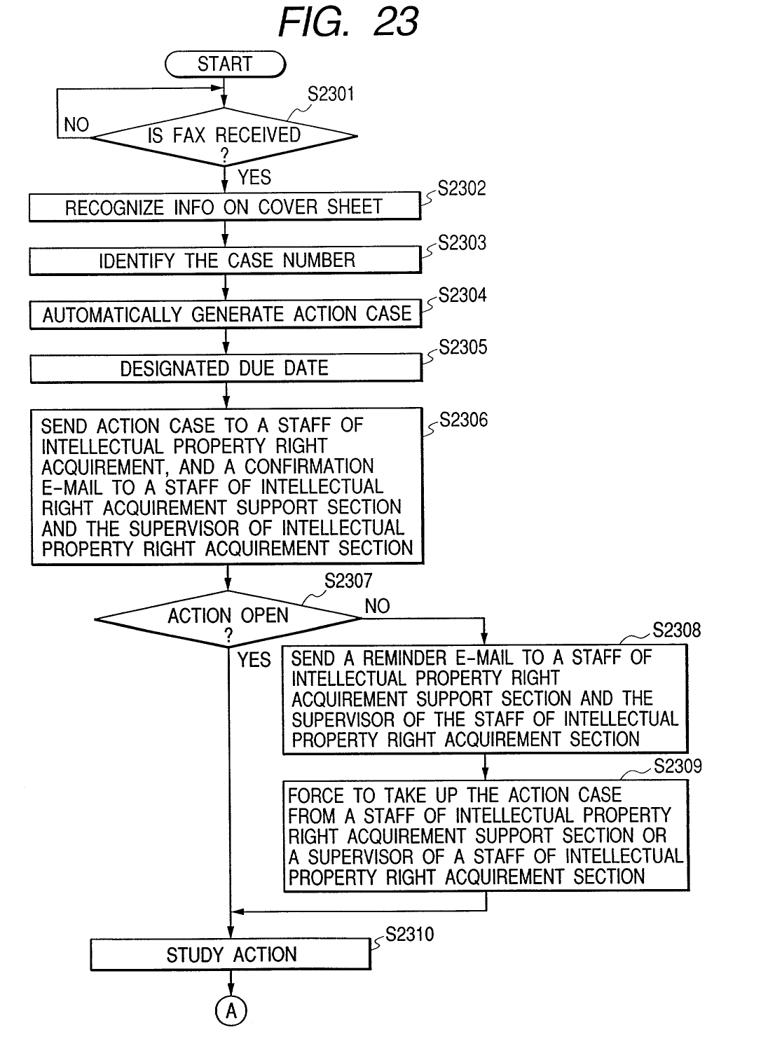

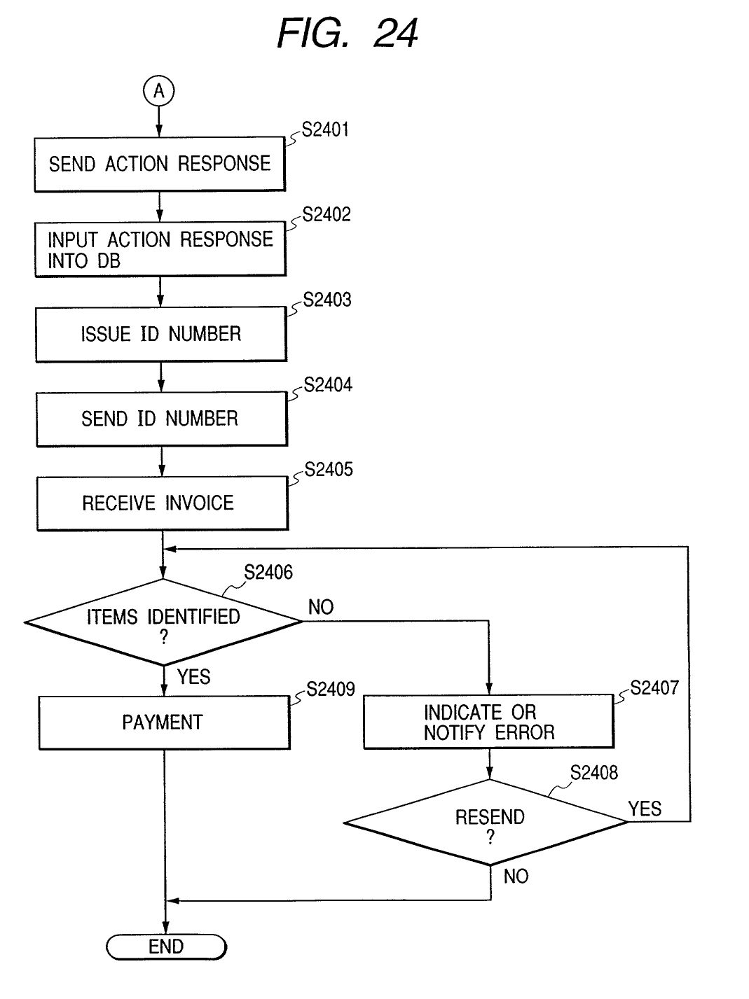

FIGS. 23 and 24 are flowcharts indicating the flow of the above mentioned process.

In these figures, facsimile data is awaited from an office, etc. in S2301. When it is received, the FAX server 2104 recognizes in S2302 the information in the above mentioned cover letter 2201 by the OCR function.

According to the present embodiment, the facsimile data contains item information (case number) for specification of a case managed by the management server 117, due date information for the current action, document name information about an attached document, attached cited document information, etc. issued by Patent Office, etc. Then, in S2302, the management information is registered in the management server 117, the document data 2202 to 2205 is registered in the document server 116, the server 119 specifies a case number, and automatically generates an action case.

A due date is set in S2305 (when a legal due date is applied, it is set, and when an office-specified due date is adopted, both dates are set). In S2306, the server 119 transmits an action case to a staff of the intellectual property right acquirement section, and transmits mail informing that an urgent action case has been received to the staff of the intellectual property right acquirement section and the boss of the staff of the intellectual property right acquirement section.

Then, in S2307, the system checks whether or not the action case has been accessed by the staff of the intellectual property right acquirement section after a predetermined time (for example, three hours) has passed. If yes, the staff studies the action in S2310.

On the other hand, if the action case has not been opened (NO in S2307), in S2308, reminder mail is transmitted to the staff in the intellectual property right acquirement support section and the boss of the staff of the intellectual property right acquirement section, and the staff in the intellectual property right acquirement support section or the boss of the staff of the intellectual property right acquirement section forcibly claims back the action case in S2309, and re-transmits the action case to another staff or process it by himself or herself.

After studying an action, in S2401, an answer to the action is transmitted through the system or by facsimile to an office through the system, and the bibliographic information in response to the action is registered in the DB of the management server 117 in S2402. Then, the server 119 issues an ID number to the action response (response request) in S2403, and the ID number is transmitted to the destination (office, etc.) of the action response in S2404. Then, in S2405, an invoice from the destination of the action response. If the item and others of the invoice match in S 2406, then the invoice amount is paid in S2409. If they do not match, then an error notification is displayed and transmitted to a destination in S2407, and the above mentioned check is repeated if re-transmission is performed in S2408.

The above mentioned ID number can be issued when urgent facsimile information is received, or an action case is issued.

Furthermore, the payment of an invoiced amount can be made online or offline.

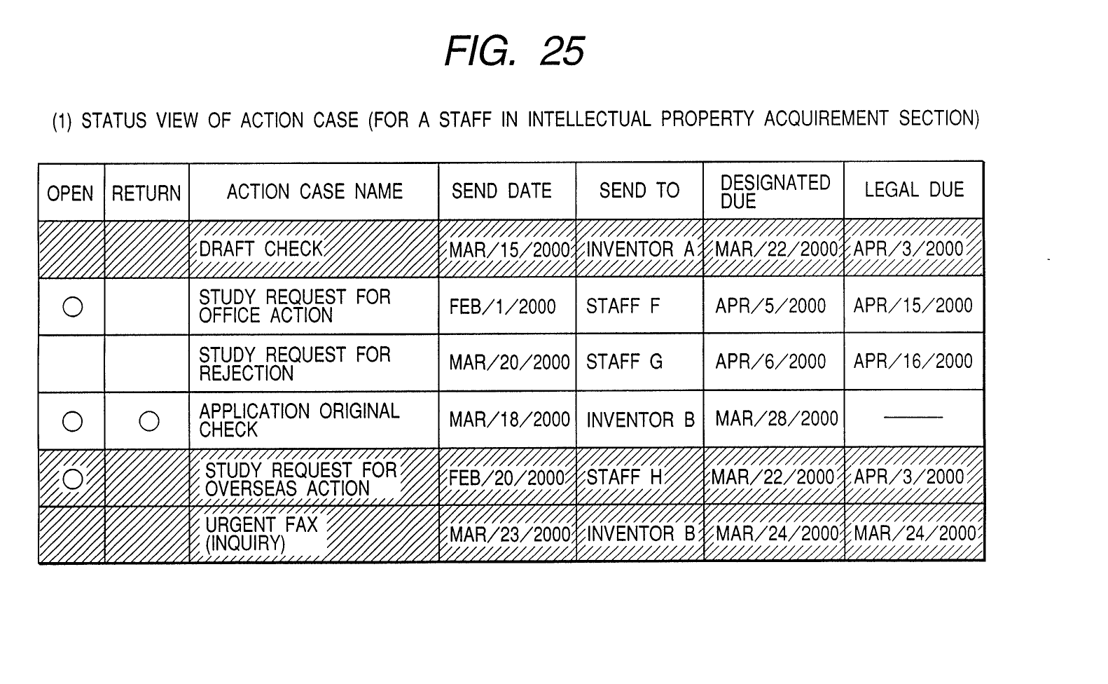

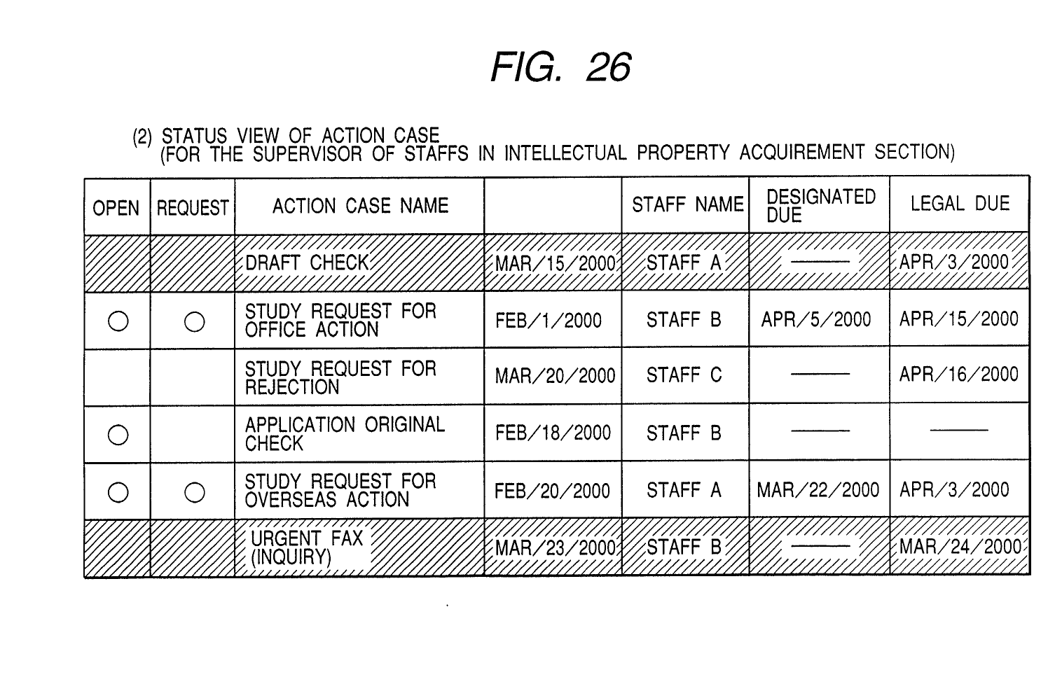

FIGS. 25 and 26 show the configuration of the display screen for a user confirming the process situation of an action case.

FIG. 25 shows an example of the display screen when the staff in the intellectual property right acquirement section confirms the process situation of an action case on the client PC.

As display items, ‘open’ indicating whether or not a person receiving an action case has accessed the action case, ‘return’ indicating whether or not the return of the action case has been received, ‘action case name’ indicating the type of action case, ‘transmission date’ indicating the date of the transmission of the action case, ‘destination’ indicating the destination of the action case, ‘specified due date’ indicating the due date of the study of the action set by the transmitter of the action case, and ‘legal due date’ indicating the due date of the document to Patent Office, etc. are sequentially displayed.

An example of a rule of the display method is described below.

1. The system detects that the action case has been accessed at the destination, and the ‘open’ box is marked.

2. If the action case is not ‘opened’ N days (for example, 3 days) after the transmission date, a visual reminder is transmitted to the staff of the intellectual property right acquirement section on the necessary display (for example, using a yellow paint) for the action case.

3. When the specified due date has been passed, the action case is painted in color (for example, blue) different from the color of 2 above regardless of whether or not the action case has been ‘opened’ as a visual reminder to the staff of the intellectual property right acquirement section (however, an already returned action case is not painted).

4. M days (for example, seven days) prior to the legal due date, the action case is painted in color (for example, red) different from the colors of 2 and 3 above regardless of whether or not the action case has been ‘opened’, or whether or not the specified due date has been passed, thereby visually reminding the staff in the intellectual property right acquirement section of the action case.

5. About the action case occurring by urgent facsimile, the action case is painted in the same color as 4 above regardless of whether or not the action case has been ‘opened’ to visually remind the staff in the intellectual property right acquirement section of the action case.

6. The conditions of the above mentioned display parameter (reminding conditions such as values of N and M, color of the paint, etc.) are set by the staff in the intellectual property right acquirement section on the client PC, and stored in the non-volatile memory of the client PC, thereby successfully customizing the process.

FIG. 26 shows an example of a display screen used when the boss in the intellectual property right acquirement section or the staff in the intellectual property right acquirement support section confirms the process situation of the action case of the staff of the intellectual property right acquirement section on the client PC.

As display items, ‘open’ indicating whether or not the staff in the intellectual property right acquirement section in charge of the action case has accessed the action case, ‘request’ indicating whether or not the action case has been transmitted in a study request, ‘action case name’ indicating the type of action case, ‘reception date’ indicating the day on which the action case was received by the staff of the intellectual property right acquirement section, ‘staff name’ indicating the name of the staff in the intellectual property right acquirement section, ‘specified due date’ indicating the due date of the study of the action set by the transmitter of the action case, and ‘legal due date’ indicating the due date of the document to Patent Office, etc. are sequentially displayed.

An example of a rule of the display method is described below.

1. The system detects that the action case has been accessed by the staff in the intellectual property right acquirement section through the network, and marks the ‘open’ box.

2. The system detects that the staff in the intellectual property right acquirement section has transmitted the action case in a study request through the network, and marks the ‘request’ box.

3. If the action case is not ‘opened’ P days (for example, 7 days) after the reception date on the staff side, a visual reminder is transmitted to the boss of the intellectual property right acquirement section on the necessary display (for example, using a red paint) for the action case.

4. If the action case is not ‘requested’ days (for example, 10 days) after the reception date on the staff side, a visual reminder is transmitted to the boss of the intellectual property right acquirement section on the necessary display (for example, using a yellow paint) for the action case.

5. About the action case occurring by urgent facsimile, the action case is painted in the same color as 3 above regardless of whether or not the action case has been ‘opened’ to visually remind boss of the staff in the intellectual property right acquirement section of the action case.

6. The conditions of the above mentioned display parameter (reminding conditions such as values of P and Q. color of the paint, etc.) are set by the boss of the staff in the intellectual property right acquirement section on the client PC, and stored in the nonvolatile memory of the client PC, thereby successfully customizing the process.

Whether or not the action case has been accessed can be recognized by the server 119 periodically checking, for example, whether or not the written study request held as an attached document of the action case by the document server 116 has been accessed.

By providing the above mentioned access check tool, the third party can issue a reminder or perform a process when a error arises in mail or the staff misses mail in a network environment, etc.

(Forcibly Claiming Back Action Case)

As described above, a person having predetermined authorization (for example, a boss of a holder of an action case, a person in charge of the management section, a person transmitting an action case to the holder) can forcibly claim back the action case.

It can be realized by, for example, rewriting the information of the work flow management table of the server 119, and changing the holder of the action case. The function is specifically effective when the process of action cases tends to be delayed because the holder of the action case is absent on the business trip, etc.

At this time, mail containing a notification that the forcible claim has been issued, the information about the person who has issued the claim, the information about the claim-back date, etc. is transmitted to the current action case holder. Thus, the action case holder can recognize that the action case held by him or her has been claimed back.

After the claim back, the action holder can perform the studying and approving processes by himself or herself, or can ask another person to study and approve the action case.

The above mentioned tool can also be used in the system according to the first embodiment.

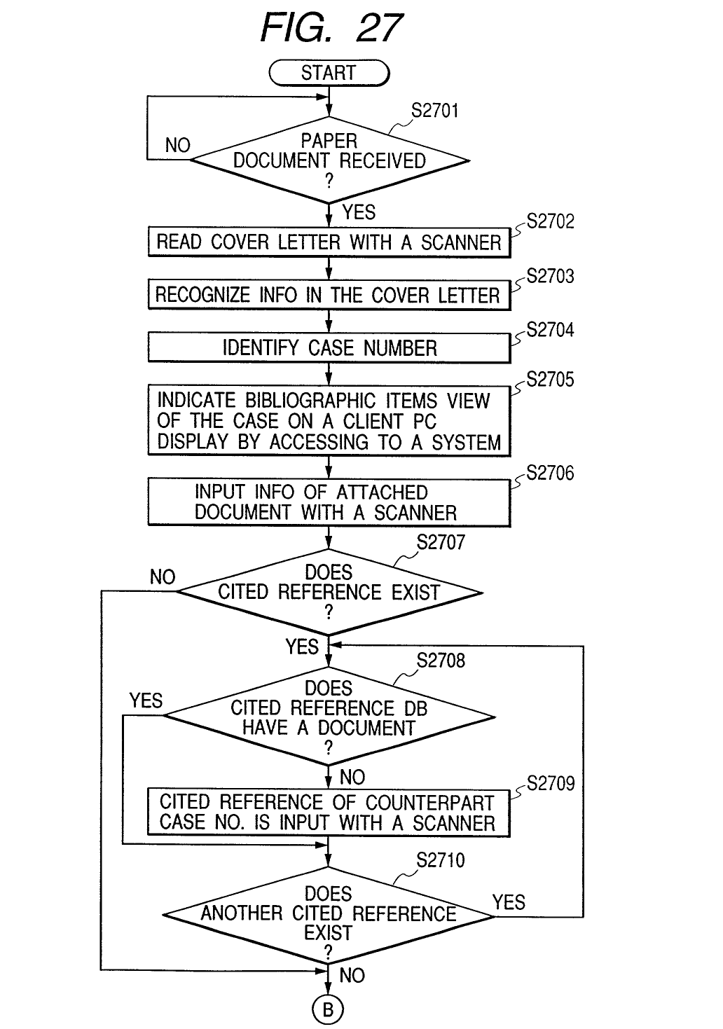

FIG. 27 is a flowchart of the method of inputting to the system a document transmitted by the above mentioned facsimile through a paper medium.

First, in S2701, the intellectual property right acquirement support section receives a paper document. The cover letter of this document can be the same as 2201 shown in FIG. 22.

In S2702, the cover letter 2201 is made to be read by the staff of the intellectual property right acquirement support section using the image scanner of 2103. In S2703, the scanner server 2102 recognizes the information in the cover letter. In S2704, a case number is specified. In S2705, the management server 117 of the system is accessed, and the bibliographic information screen of the corresponding case is displayed on the display unit of 2102, which is a client PC.

Next, the attached document (for example, a notice of reasons for rejection) 2202 is input in S2706. It is determined in S2707 whether or not a cited document has been attached. If yes, it is determined whether or not the cited document has been stored in the server 118 forming part of the DB of the cited document. If it has been already stored, the cited document is not input by the scanner. On the other hand, if the cited document is not contained in the cited document DB, then the staff in the intellectual property right acquirement support section is prompted on the screen of the PC to input a cited document having the corresponding number with a scanner in S2709. If there is another cited document, the processes in S2708 to S2709 are repeated. Afterwards, the processes in S2801 to S2806 are similar to the processes in S2305 to S2310 shown in FIG. 23. Therefore, the detailed explanation is omitted here. Then, the process in FIG. 24 is performed.

(Document Database)

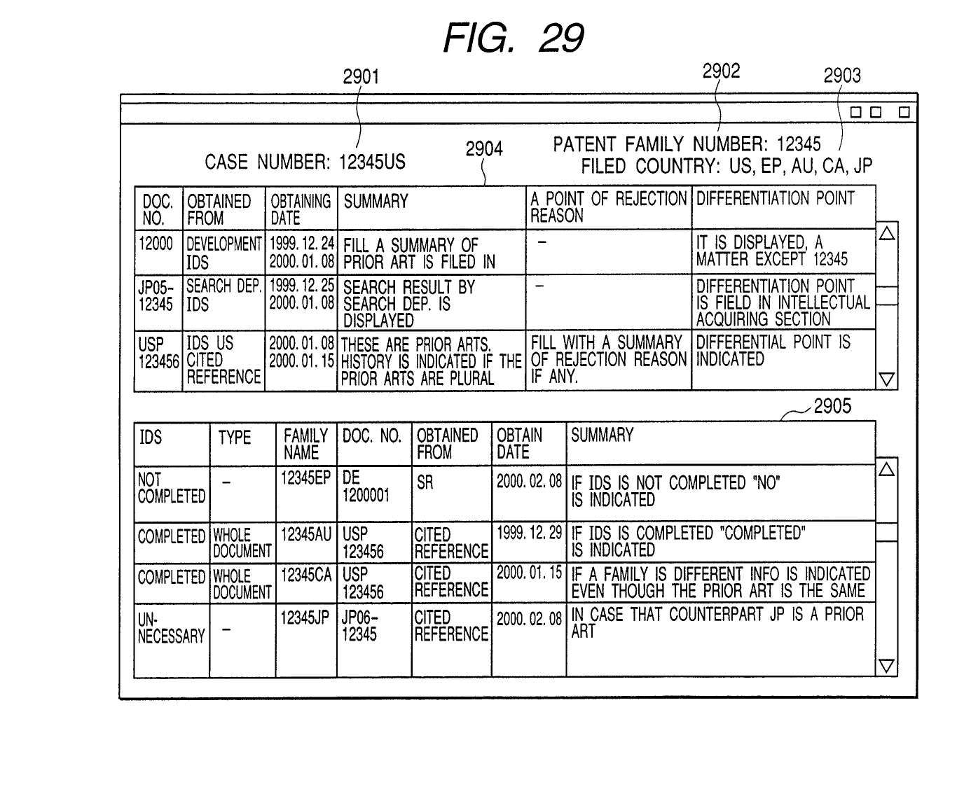

FIGS. 29 to 33 show the display screen of the client PC for explanation of the method of using the cited document database provided in the server 118.

FIG. 29 shows a list of related documents for each case number (case). Reference numeral 2901 denotes a case number, that is, the reference number of the application of the company in each country. In this example, a five-digit number is followed by alphabetical character identifying a country. Reference numeral 2902 denotes a family number indicating an application group practically equivalent in contents of application. Reference numeral 2903 denotes a filed country. In this case, there are the applications of US (the United States), EP (Europe), AU (Australia), and JP (Japan). Reference numeral 2904 denotes a document list relating to the US Patent application of the case number 12345US, and has been cited mainly in the examination by US Patent Office.

In this example, three cases having the document numbers ‘12000 (in-house family number)’, ‘Japanese Patent Application Laid-Open No. 05-12345’, and ‘USP123456’ are listed.

In each document number, items such as a source, an obtaining date, a summary, a point of rejection, a differentiation point in the present application, etc. are displayed, Reference numeral 2905 displays all related documents of the family (in this case, US, EP, AU, and JP) of the case. In this example, four cases except the US case, that is, ‘DE1200001’ in the EP case, ‘USP123456’ in the AU case, ‘USP123456’ in the CA case, and ‘Japanese Patent Application Laid-Open No. 06-12345’ in the JP case, are cited. The source (for example, a search report (SR), the obtaining date, the summary, etc. of each case are displayed. Furthermore, the IDS information indicating whether or not the IDS (information disclosure procedure) has been completed in the U.S. (US) and China (CN) is displayed together. The IDS information can be displayed by one flag with US combined with CN as shown in FIG. 29. US and CN can have respective information, and can be displayed independently.

Thus, the related documents can be displayed for each family, and the status of the IDS of the related documents can be displayed, thereby preventing the omission of the IDS, easily considering documents cited in the examinations in other countries for acquirement of a patent right, and efficiently acquiring effective right.

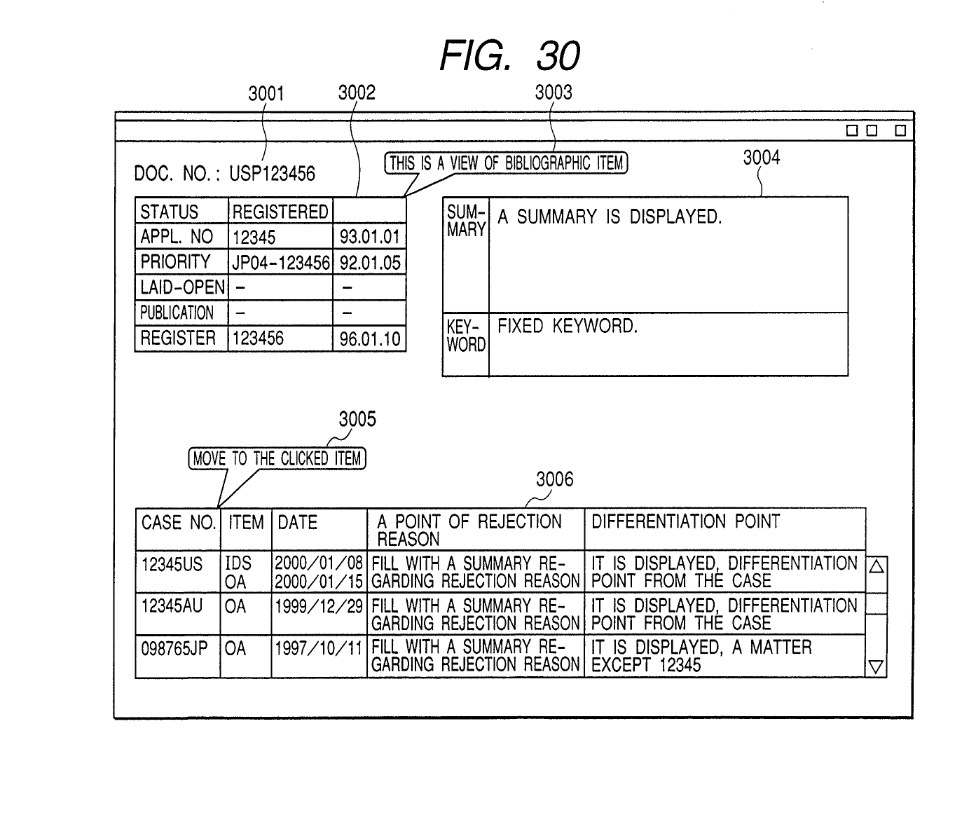

FIG. 30 shows the display screen (type 1) for reverse tracing by a document. Reference numeral 3001 denotes a document number. Reference numeral 3002 denotes the bibliographic information displaying, for example, the current status, the application number, the filing date, the priority-based application number and the priority day, the laid-open number and the laid-open date, the publication number and the publication date, the registration number and the registration date. Reference numerals 3003 and 3005 are guide displays. By pointing to a portion with the cursor, the function of the portion is displayed. Reference numeral 3004 denotes the summary of the document. Reference numeral 3006 denotes a listing of the in-house cases (case numbers) in which the document has been cited. In this example, when a case number is clicked, the in-house application information registered in the document server 116 can be accessed. In addition, in this example, the item (an office action, etc. in history unit), the date, the portion of the rejection, the differentiation point from the present invention, etc. are displayed for each case number.

Thus, by extracting and displaying an in-house case number by which the document can been cited using the document as a key, the point used when differentiation can be made from the document in other cases can be immediately detected, thereby efficiently studying the office action.

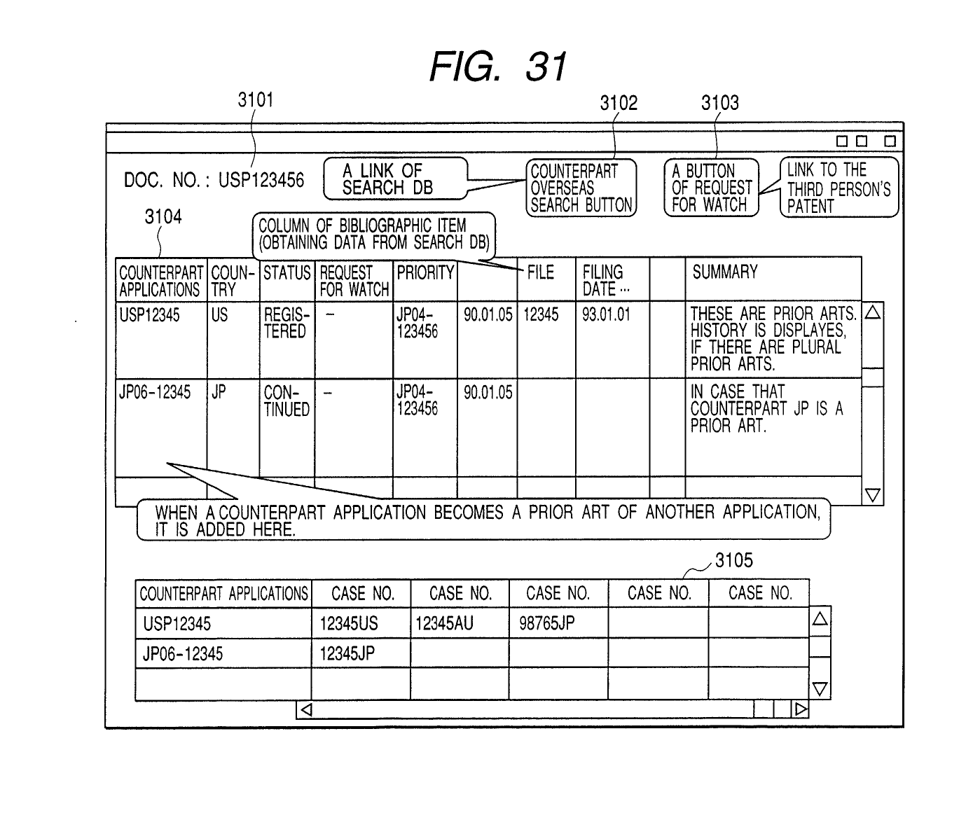

FIG. 31 shows a display screen for reverse tracing by documents (type 2). Reference numeral 3101 denotes a document number. Reference numeral 3102 denotes a counterpart foreign application retrieval button. When it is pressed, a link to the patent retrieval DB of the server 118 is established, thereby inspecting a document of the family (for example, the US application, the Japanese application, etc.). Reference numeral 3103 denotes a button of request for an in-house procedure of automatically watching the condition (registration, deletion, or the like) of the document. Reference numeral 3104 denotes a list of the bibliographic information of the family of the document cited in any case. Reference numeral 3105 denotes a list of cases obtained by inversely tracing the case numbers by which documents are cited. For example, it is immediately indicated that ‘USP12345’ is a document cited by the case numbers ‘12345US’, ‘12345AU’, and ‘098765JP’.

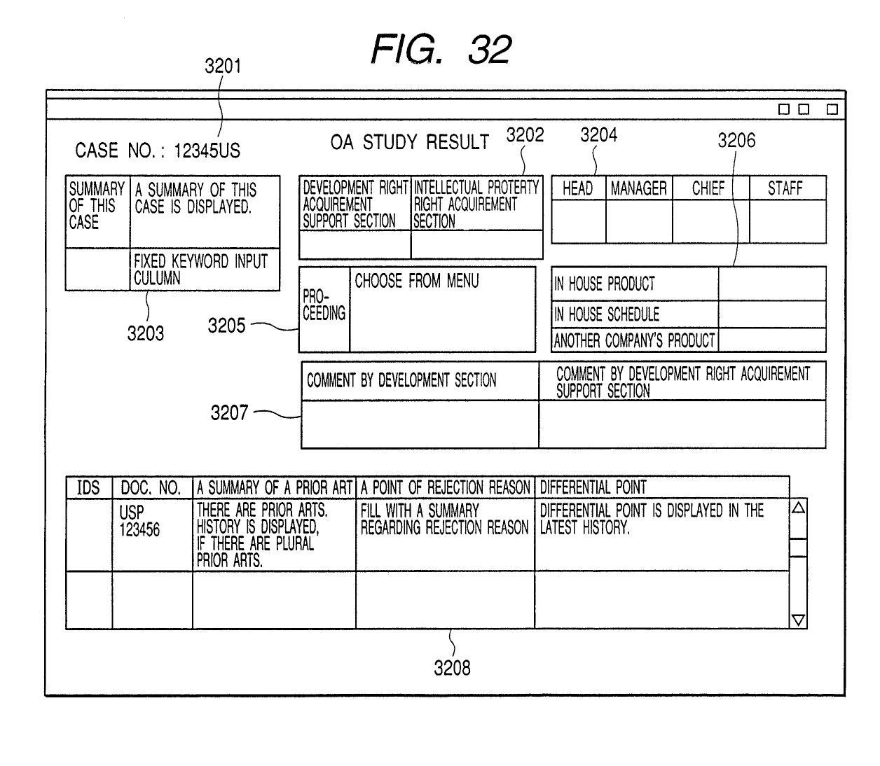

FIG. 32 shows the result (one history unit of one case) of the study of an office action processed in an action case.

Reference numeral 3201 denotes the case number of the present case. Reference numeral 3202 the names of the staffs in the development right acquirement support section and the intellectual property right acquirement section and their access addresses. Reference numeral 3203 denotes the summary of the present case. Reference numeral 3204 denotes an approval stamp. Reference numeral 3205 denotes the type of office action. Reference numeral 3206 denotes a product of the company, the execution plan of the company, and the products of other companies in which the invention of this case is implemented. Reference numeral 3207 denotes comments of the studying persons in the development section and the development right acquirement support section. Reference numeral 3208 denotes a list of the documents cited in the case. The list shows items of a flag indicating whether or not the document has been disclosed by the prior art in US and CN, the summary of the cited document, the portion corresponding to the notice of reasons for rejection, and the differentiation point.

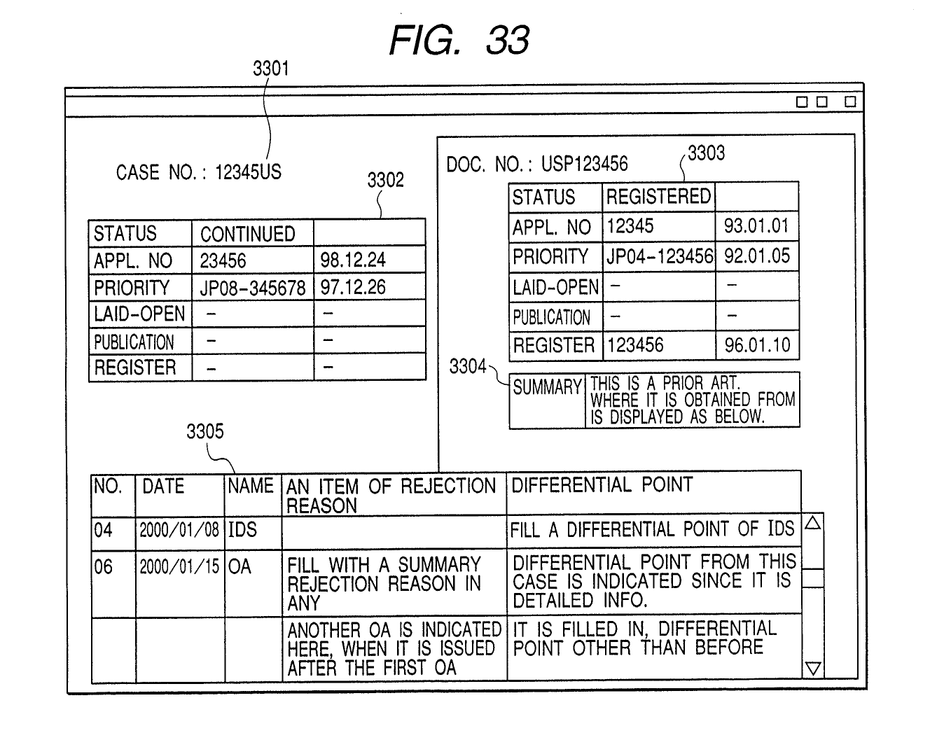

FIG. 33 shows the display screen of the related documents in each case unit. Reference numeral 3301 denotes a case number. Reference numeral 3302 denotes the current situation of the case number, the bibliographic items such as the application, laid-open, registration number, etc. Reference numeral 3303 denotes a bibliographic items of the related documents. Reference numeral 3304 denotes the summary of the document. Reference numeral 3305 denotes a list of the obtaining date of the document, an acquirement method, a counterpart portion of a rejection, a differentiation point, etc.

As described above, by having information about related documents for each application case and history, a document can be retrieved and displayed in case and history units, and a case can be retrieved and displayed in document units. As a result, the efficiency in performing a right acquiring process by studying a notice of reasons for rejection can be considerably improved. Especially when documents are managed in a paperless process in a network environment, a document database managed in case and history units is effective.

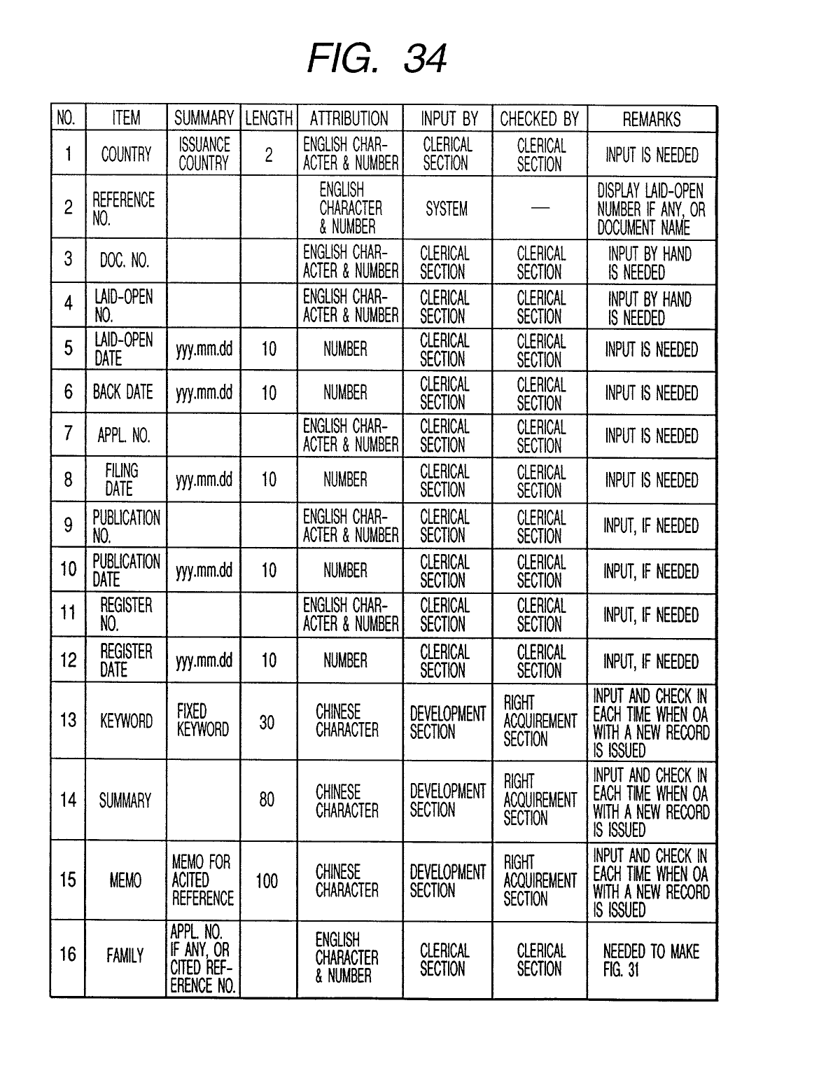

FIGS. 34 to 36 are tables for explanation of the definition of a DB management item used to set the above mentioned database.

FIG. 34 is a table showing the information managed for each document, and defines items of an issuance country, a reference number, a document number, a laid-open number, a laid-open date, a back date, an application number, a filing date, a publication number, a publication date, a register number, a register date, a keyword, a summary, a memo, and a family. For each item, a summary, a length, an attribute, a person who inputs the item, a checker, and a note are entered.

For example, the item name ‘issuance country’ refers to a country which issues the document, the length is two alphanumeric characters, a person who inputs items and a checker belong to the clerical section (intellectual property right acquirement support section), and the note indicates that data input is required. According to the rule, a document database is generated.

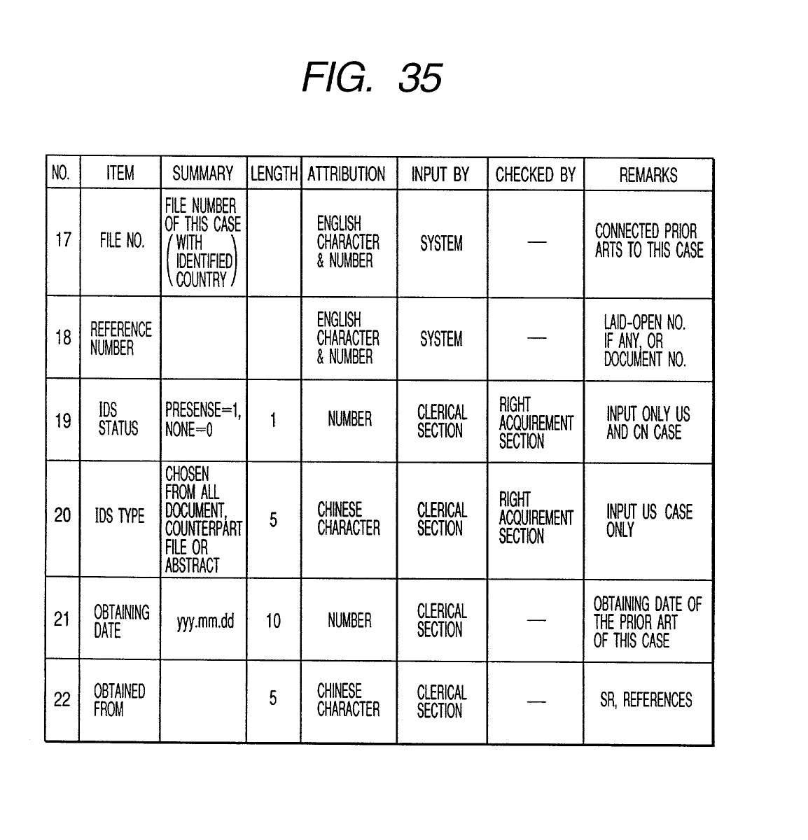

FIG. 35 is a table indicating the information for each case (corresponding to a case number), and defines items of File No., a reference number, an IDS status, an IDS type, an obtaining date, and a source. Each item is defined as in FIG. 34.

For example, the item ‘File No.’ can specify an issuance country, the attribute is an alphanumeric character, a person who inputs data refers to system automatic input, no checker is set, and the memo indicates the item connecting the prior art to this case.

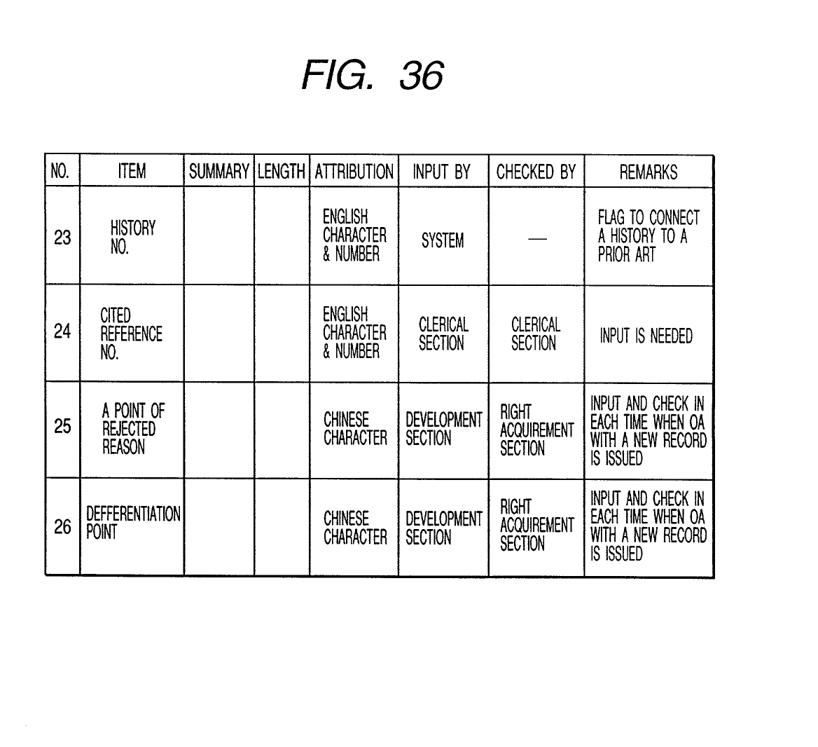

FIG. 36 contains the information for each reference of each history (for example, corresponding to the above mentioned action case) of each case (corresponding to a case number), and defines items of a history number, a reference number, a point of rejection, and a differentiation point. Each item is defined as in FIG. 34.

For example, for the item ‘reference number’, the attribute is an alphanumeric character, a person who input data and a checker belong to the clerical section, and the note indicates that data input is required.

By inputting the above defined items, the above mentioned DB management, retrieval, and display can be realized.

(Third Embodiment)

A third embodiment of the present invention will be described below by referring to the attached drawings.

In this embodiment, the intellectual property management system shown in FIG. 1 communicates information with the Patent Office 113 through the domestic firm 112. The configuration shown in FIG. 1 is described above.

(Information through Domestic Firm)

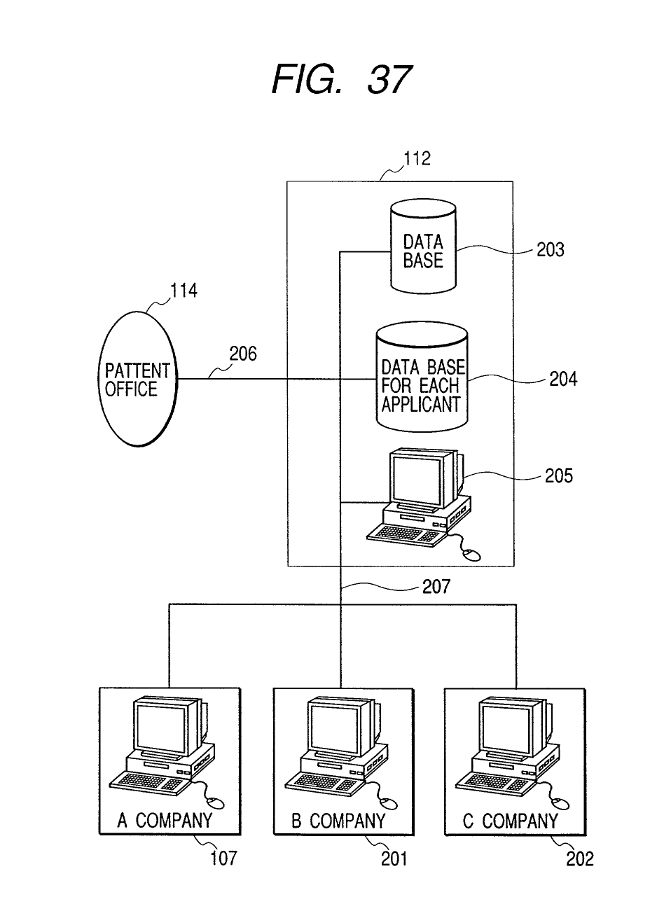

FIG. 37 shows the process performed when the head office 107 communicates information with the Patent Office 114 through the domestic firm 112.

In FIG. 37, reference numeral 107 denotes a head office of Corporation A, reference numeral 201 denotes Corporation B, and reference numeral 202 denotes Corporation C. Each corporation performs a procedure with the Patent Office 114 through a domestic firm (attorney's office, law and patent office).

Reference numeral 203 denotes a database connected to the network in the domestic firm 112, and stores the information transmitted to and received from Patent Office. Reference numeral 204 denotes a storage device storing data by applicants connected to the network in the domestic firm 112. Reference numeral 205 denotes a host computer connected to the network in the domestic firm 112. The domestic firm 112 is connected to Patent Office 114 through Internet and a telephone line 206. Similarly, the domestic firm 112 is connected to the head office 107, and the Corporation B 201 is connected to the Corporation C 202 also through Internet and a telephone line 207.

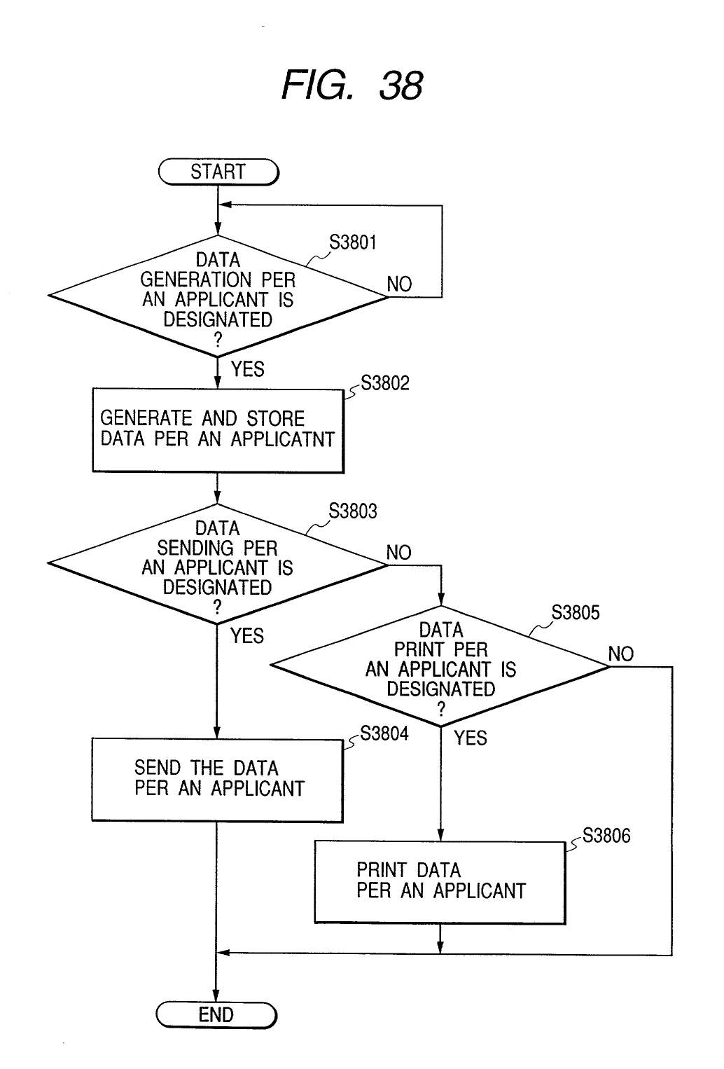

FIG. 38 is a flowchart of the process of transmitting data relating to each application case to each applicant, that is, a requester, in the domestic firm 112.

First, in step S3801, it is determined whether or not an instruction to generate data by applicants from the data stored in the database 203 has been issued from an operator of the host computer 205. If yes, the data is generated by applicants, and stored in the storage device 204.

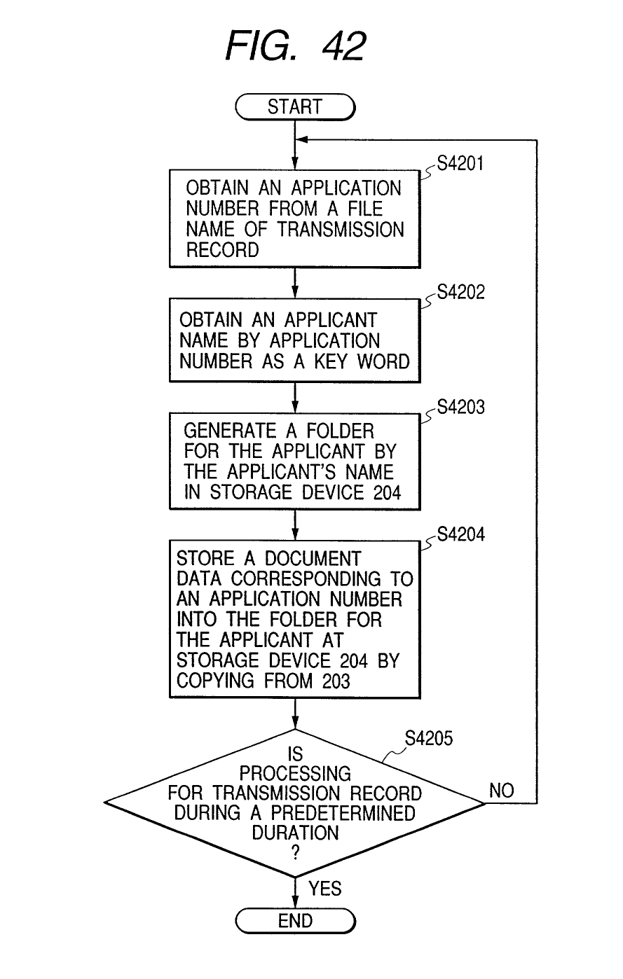

The procedure of generating data by applicants will be described below by referring to the flowchart shown in FIG. 42.

The record of transmission/reception of data to and from Patent Office 114 is stored in the host computer 205. On the other hand, the database 203 stores document data of documents submitted to Patent Office, and documents such as a notice of rejection transmitted from Patent Office. Thus, the transmission/reception record and document data are accumulated at any time.

When an instruction to generate data by applicants is issued, an application number is acquired from the file name of the first case in the transmission/reception record (step S4201). The name of an applicant is extracted using the application number as a key by referring to the database 203 storing the correspondence between the application number and the applicant name and the bibliographic information such as the reference number unique to each company (step S4202).

The folder of the applicant is generated from the acquired applicant name in the storage device 204 (step S4203). Then, the document data corresponding to the application number is copied from the database 203, and the data is stored in the corresponding applicant holder in the storage device 204 (step S4204).

The above mentioned process is repeated for a target case of a transmission/reception record transmitted and received in a predetermined period (step S4205).

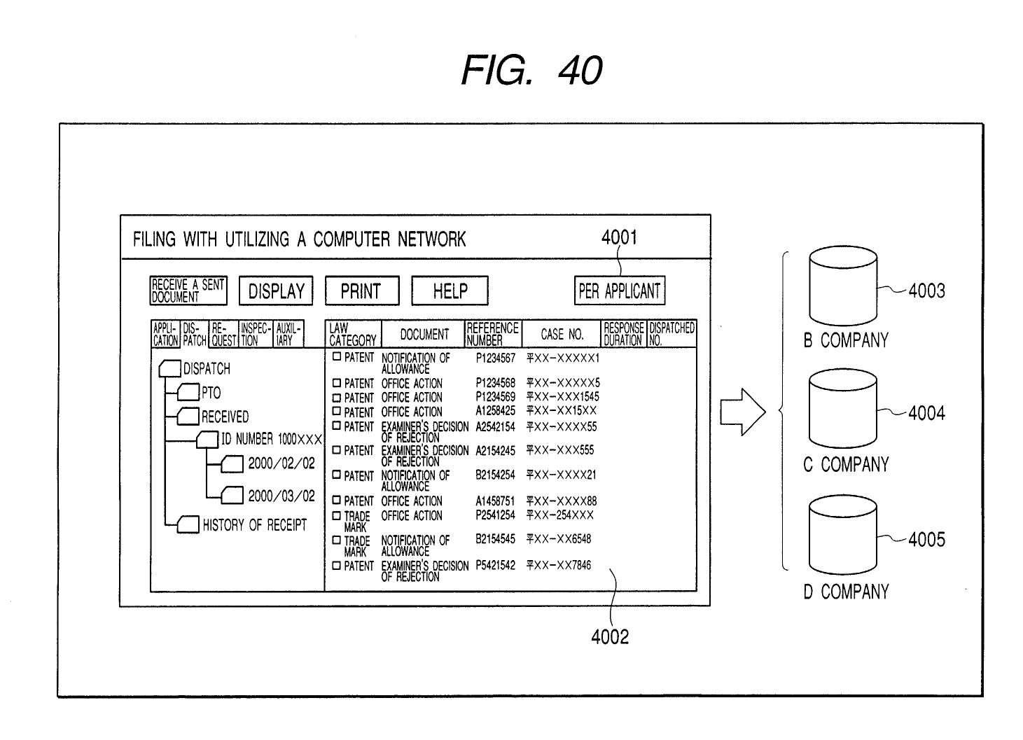

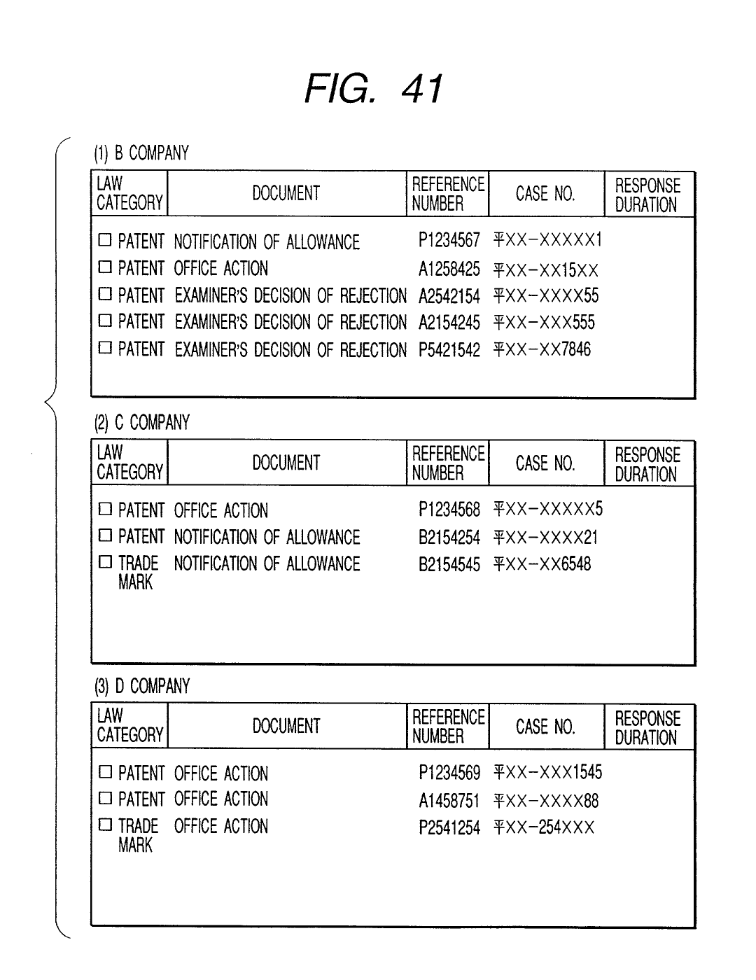

FIG. 40 shows an example of a monitor of the host computer 205, and the above mentioned instruction to generate data by applicants is issued by clicking an applicant category button 4001. Reference numeral 4002 denotes a list of a reception record. After generating data by applicants as described above, icons accumulating data by applicants are generated as 4003 to 4005 on the desk top. For example, by clicking 4003, a list of data of documents applied by a corporation B as shown in FIG. 41(A) is displayed on the monitor of the host computer 205. Similarly, when the icon 4004 is clicked, FIG. 41(B) is displayed, and when the icon 4005 is clicked, FIG. 41(C) is displayed.

Back in FIG. 38, if it is determined in step S3803 that an instruction to transmit data by applicants to a company has been issued by the host computer 205 for the data of the documents accumulated in the host computer 205 by applicants, then the data by applicants is transmitted to the companies 107, 201, and 202 depending on the respective instructions in step S3804. On the other hand, if it is determined in step S3805 that an instruction to print data by applicants has been issued by the host computer 205, then the data by applicants is printed out in step S3806.

Thus, by selecting transmission or printout for each applicant, data is transmitted to an applicant having an online terminal, and is printed on a paper medium for an applicant having no terminals, thereby transmitting a document without fail to each applicant.

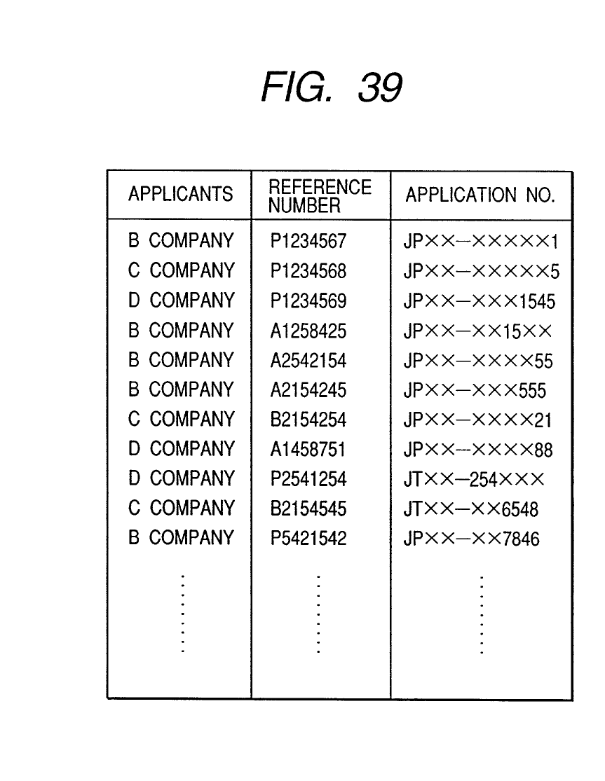

The table showing the correspondence between an application number and the bibliographic information such as an applicant name, a reference number unique to each company, etc. is stored in the database 203 of the domestic firm 112 as shown in FIG. 39. However, for example, the table can also be stored in the management server 117 of the intellectual property information management section, and can be referred to online through the telephone line 207. In this case, it is not necessary to provide the table in the domestic firm 112, thereby reducing the managing process of the firm.

Furthermore, an application number is acquired from the file name of the first case in the transmission/reception record, but an applicant name can be extracted from the document data stored in the database 203.

On the other hand, the host computer 205 generates data by applicants. However, this function can be performed by an applicant, and the applicant can online access the database 203 of the domestic firm through the telephone line 207 so that the applicant can selectively retrieve the document data of the domestic firm.

(Fourth Embodiment)

A fourth embodiment of the present invention will be described below by referring to the attached drawings.

According to the present embodiment, the intellectual property management systems shown in FIG. 1 are provided in a plurality of countries to communicate information among them. The configuration shown in FIG. 1 is described above.

(Flow of Information in Intellectual Property Management System)

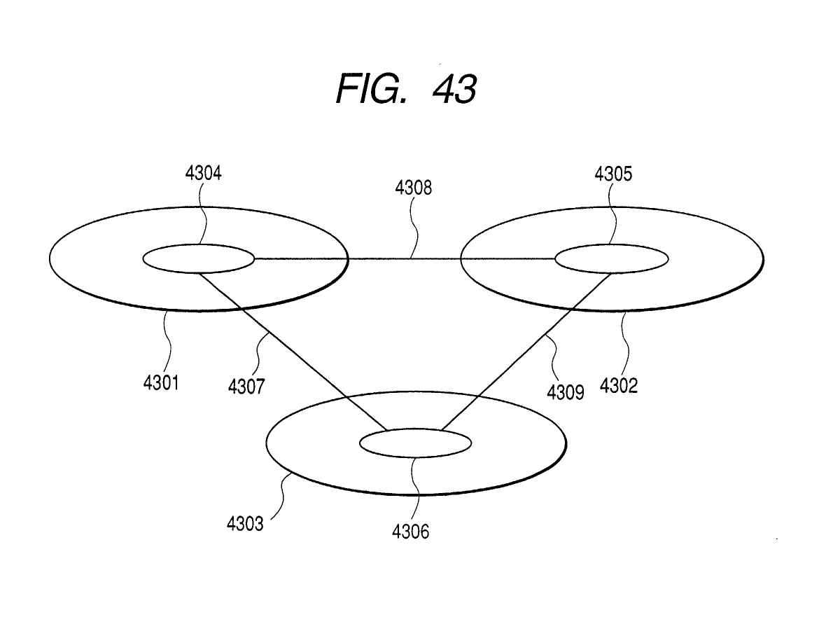

FIG. 43 shows the information management in a network environment connecting the intellectual property management systems provided in a plurality of countries.

In FIG. 43, reference numeral 4301 denotes a country A (for example, Japan), reference numeral 4302 denotes a country B (for example, U.S.), and reference numeral 4303 denotes a country C (for example, England).

In addition, reference numerals 4304, 4305, and 4306 denote the intellectual property management systems provided in the countries A, B, and C as shown in FIG. 1. Reference numerals 4307, 4308, and 4309 denote networks connecting the intellectual property management systems of the countries A, B, and C. The networks are connected to the systems of the respective countries through communications lines.

Described below will be the transmission of the information about inventions from the country B (U.S.) to the country A (Japan).

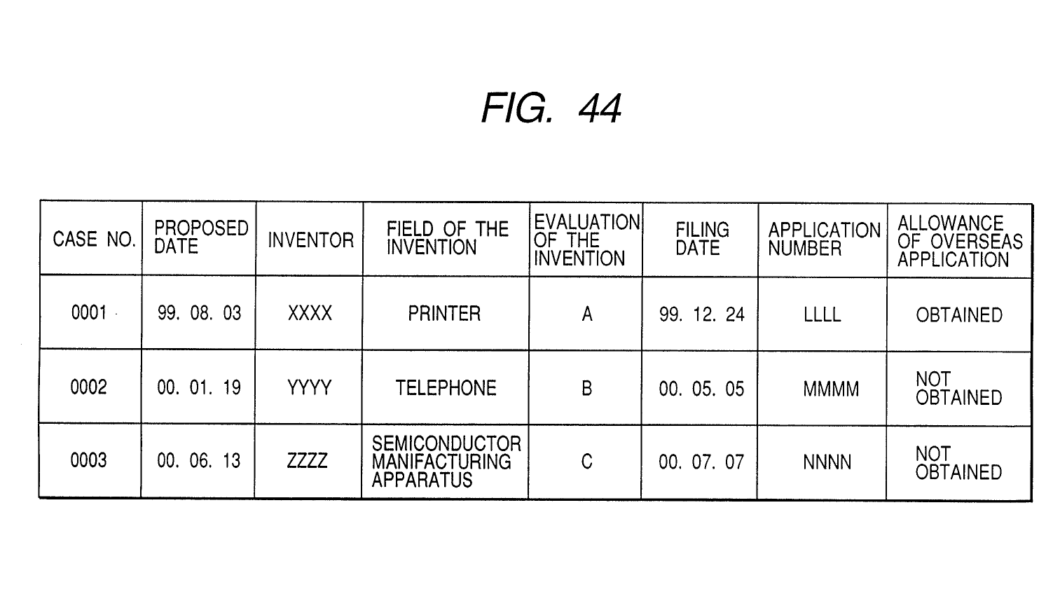

FIG. 44 shows an example of storage items of the management server 115 in the country B. The management server 115 stores the bibliographic information such as a proposal date, an applicant, the field of an invention, the evaluation of an invention, an application date, an application number, etc. for each case number of each patent application. Furthermore, a flag indicating whether or not the foreign application permission referred to as the Foreign Filing License in the U.S. Patent Law has been acquired is stored for each case number.

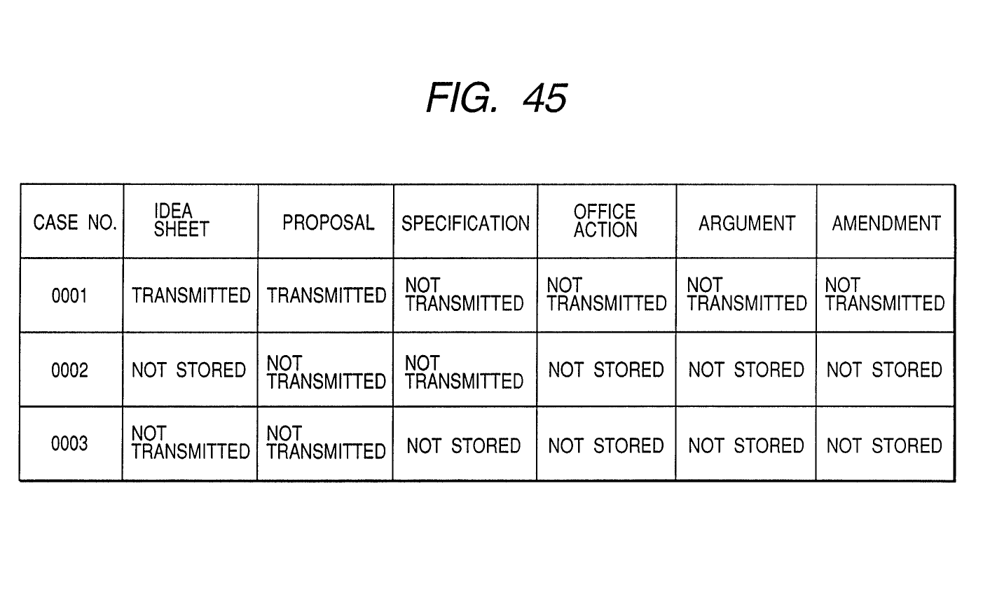

FIG. 45 shows an example of a document stored in the document server 114 in the country B. The document server 114 can store documents such as an idea sheet (documents describing the summary of the invention), a proposal document (describing the detailed explanation of the invention), the specification of an application, a notice of rejection, an argument, an amendment, etc.

In FIG. 45, for example, the case number 0002 indicates that the proposal document and the specification of the application have been stored.

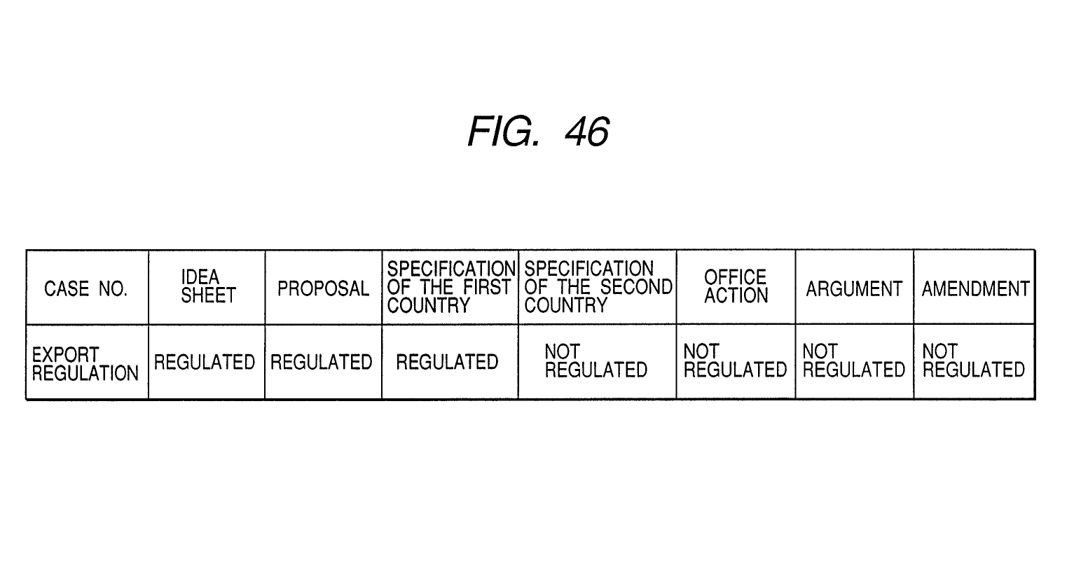

FIG. 46 is a table specifying a document to be restricted in exporting information. For example, an idea sheet, a proposal document, and an application specification for the first country are to be restricted. On the other hand, an application specification for the second country, a notice of rejection, an argument, and an amendment are not to be restricted.

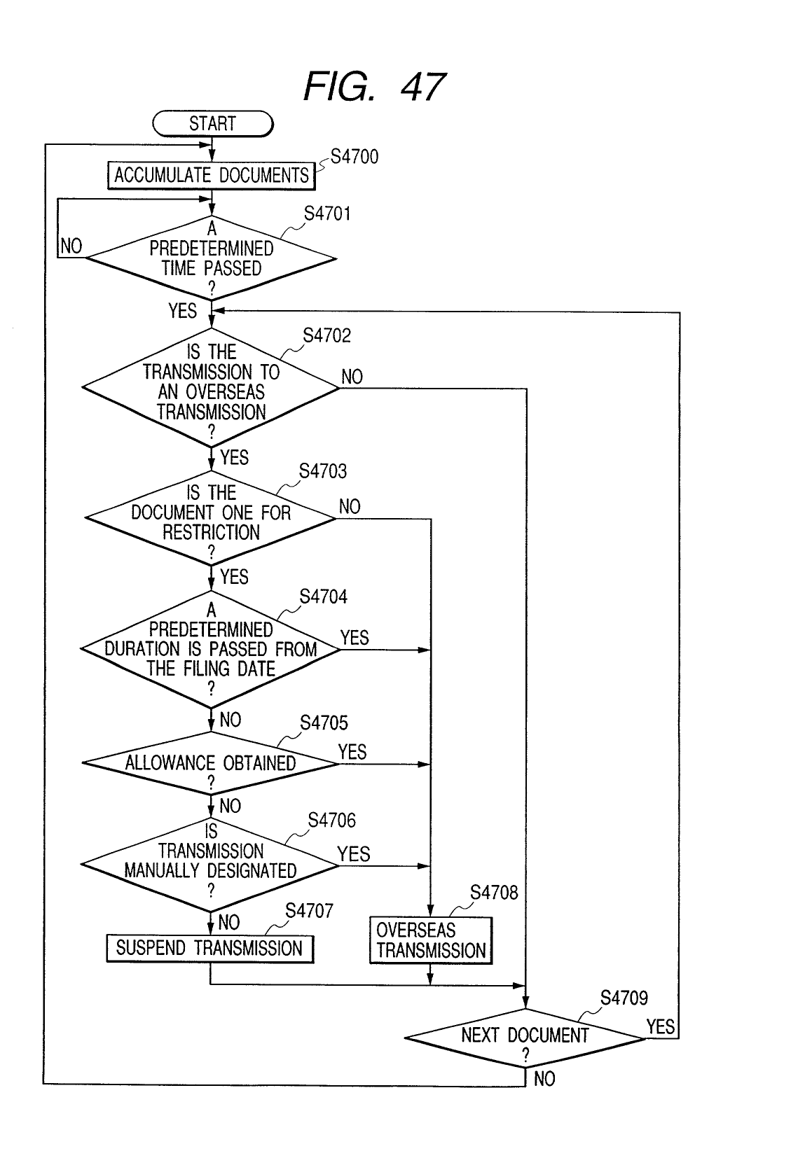

FIG. 47 is a flowchart describing the decision made by the server 118 of the country B when transmitting a document overseas.

First, in step S4700, documents such as an idea sheet, a proposal document, the specification of an application, a notice of rejection, an argument, an amendment, etc. are accumulated in the document server 114, and it is determined in step S4701 whether or not a predetermined time has passed. For example, when one day has passed, a document transfer process to overseas is started at midnight.

Then, in step S4702, it is determined whether or not the document is to be transmitted overseas. If not, the process is omitted, and control is passed to the determination as to whether or not there is another document (step S4703).

On the other hand, in the case of a document to be transmitted overseas, the table (stored in the management server 115) shown in FIG. 46 is referred to, and it is determined whether or not the document is to be restricted in overseas transmission. If not, the document is transmitted overseas in step S4708. When it is a document to be restricted, it is determined in step S4704 whether or not a predetermined period has passed from the application date because there is the regulations of the U.S. Patent Law that the restrictions expire if six months have passed from the application date. If the predetermined period has passed, the document is transmitted overseas in step S4708.

If the predetermined period has not passed, a predetermined permission is obtained in step S4705, and it is determined whether or not the document has entered a state in which overseas transmission is permitted. The overseas transmission is permitted by the U.S. Patent Law if the Foreign Filing License has been acquired. This type of license is stored in the document server 114, and a flag as shown in FIG. 44 is set in the management server 115. Based on the flag, it is determined in step S4705. If the license has been acquired, the overseas transmission is performed (step S4708). On the other hand, if the license has not been acquired, it is determined in step S4706 whether or not an instruction to transmit the document has been manually issued. For example, as a case number 0001 in FIG. 44 when it is clear that the technical field of the document is not restricted as in the case of a printer, etc., the manager of the server can issue a transmission instruction based on his or her technical determination. When such an instruction is issued, overseas transmission is performed (step S4708).

In this case, the manager who has issued the transmission instruction inputs and stores a case which is the reference of the determination.

On the other hand, if there is no such instructions issued, then the transmission is suspended (step S4707), and control is passed to the process of the subsequent documents (step S4709). If there are subsequent documents (including the documents suspended for transmission in the previous determination) to be processed, then control is returned to step S4702. Otherwise, the overseas transmission process is terminated, and the subsequent documents are accumulated. The determination as to whether or not the document has been suspended (whether the document has not been transmitted) is performed by checking on the management table shown in FIG. 45 whether or not the document has been transmitted.

As described above, according to the present embodiment, documents can be managed with the laws and regulations completely observed by managing the possibility of the overseas transmission of documents of electronic data based on the factor such as the type and the transmission period of the documents.

The present invention can also be attained by providing a storage medium storing a program code of software realizing the function of the above mentioned embodiments in a system or a device, and by the computer (or the CPU or the MPU) in the system or the device reading and executing the program code stored in the storage medium.

In this case, the program code itself read from the storage medium realizes the function of the above mentioned embodiments, and the storage medium storing the program code configures the present invention. The storage medium for providing a program code can be, for example, a floppy disk, a hard disk, an optical disk, a magneto-optical disk, CD-ROM, a CD-R, a magnetic tape, a non-volatile memory card, ROM, etc.

Furthermore, the functions according to the above mentioned embodiments can be realized not only by executing the program code read by the computer, but also by the OS (operating system), etc. operating in the computer performing all or a part of the actual process at an instruction of the program.

In addition, after a program code read from the storage medium has been written to the memory provided in an extension board and a function extension unit inserted to the computer, the CPU, etc. provided in the function extension board or the function extension unit performs all or a part of the actual process at an instruction of the program code, thereby realizing the functions of above mentioned embodiments.

Furthermore, the concepts of the work flow, the generation of a database, the configuration of a system, etc. in the above-described embodiments can be arbitrarily transformed and combined appropriately.

What is claimed is:

1. An information processing apparatus for studying a target case by communicating information through a network, comprising:
first communications means for requesting from a first inspector to a second inspector to study the target case with first information attached; and
second communications means for transmitting second information not contained in said first information to said second inspector for study of said target case when a study request is issued by said first communications means.

2. The information processing apparatus according to claim 1, further comprising:
third communications means for requesting from said second inspector to a third inspector to study said target case; and
fourth communications means for transmitting said second information to said third inspector.

3. The information processing apparatus according to claim 2, further comprising:
fifth communications means for transmitting to said second inspector third information used to allow said second inspector to access said second information when said fourth communications means transmits said second information to said third inspector.

4. The information processing apparatus according to claim 1, further comprising:
detection means for detecting an owner of a right to request another inspector to study said target case.

5. An information processing method for studying a target case by communicating information through a network, comprising:
first communications step of requesting from a first inspector to a second inspector to study the target case with first information attached; and
second communications step of transmitting second information not contained in said first information to said second inspector for study of said target case when a study request is issued by said first communications means.

6. A program storage medium storing a program for performing an information processing method for studying a target case by communicating information through a network, comprising:
a code for performing a first communications step of requesting from a first inspector to a second inspector to study the target case with first information attached; and
a code for performing a second communications step of transmitting second information not contained in said first information to said second inspector for study of said target case when a study request is issued by said first communications means.

7. An information processing apparatus for fetching facsimile data received through a line into a database, comprising:
reception means for receiving the facsimile data; and
retrieval means for retrieving a specified item in the database from said facsimile data.

8. The information processing apparatus according to claim 1, wherein
said facsimile data contains identification information about a specified item stored in said database.

9. The information processing apparatus according to claim 8, wherein said facsimile data further contains due date information about a specified item stored in said database.

10. The information processing apparatus according to claim 8, wherein said facsimile data further contains attached document information about a specified item stored in said database.

11. The information processing apparatus according to claim 10, wherein said attached document information refers to a name of a document received from Patent Office and/or a name of a cited document.

12. The information processing apparatus according to claim 7, further comprising management means for receiving said facsimile data, and automatically generating a work flow in a network according to information contained in the facsimile data.

13. The information processing apparatus according to claim 12, wherein said work flow contains due date management and mail transmission.

14. An information processing method for fetching facsimile data received through a line into a database, comprising the steps of:
receiving facsimile data; and
retrieving a specified item in a database from said facsimile data.

15. A program storage medium storing a program for realizing an information processing method for fetching facsimile data received through a line into a database, comprising:
a code for realizing a receiving step of receiving facsimile data; and
a code for realizing a retrieving step of retrieving a specified item in a database from said facsimile data.

16. An information processing apparatus for processing document data by communicating information, comprising:
first storage means for storing a transmission/reception record of a document transmitted to or received from Patent Office;
second storage means for storing document data of said document;
acquisition means for acquiring an application number from the transmission/reception record stored in said first storage means or the document data stored in said second storage means;
a table storing data showing correspondence between an application number and an applicant; and
extraction means for extracting document data of a document stored in said second storage means and related to said application number by referring to said table using the application number obtained by said acquisition means as a key.

17. The information processing apparatus according to claim 16, further comprising holding means for holding the document data extracted by said extraction means in a holder for each applicant.

18. The information processing apparatus according to claim 17, further comprising transmission means for transmitting the document data held in said holder to a corresponding applicant.

19. The information processing apparatus according to claim 17, further comprising printing means for printing the document data held by said holder by applicant.

20. The information processing apparatus according to claim 16, wherein said data stored in said table indicates an applicant of an application corresponding to said application number.

21. An information processing method for processing document data by communicating information, comprising the steps of:
storing a transmission/reception record of a document transmitted to or received from Patent Office in first storage means;
storing the document data of said document in second storage means;
acquiring an application number from the transmission/reception record stored in said first storage means or the document data stored in said second storage means; and
extracting document data of a document stored in said second storage means and related to said application number by referring to a table storing data showing correspondence between an application number and an applicant name using the application number as a key.

22. A program storage medium storing a program for realizing an information processing method for processing document data by communicating information, comprising the steps of:
a code for realizing a storing step of storing a transmission/reception record of a document transmitted to or received from Patent Office in first storage means;
a code for realizing a storing step of storing the document data of said document in second storage means;
a code for realizing an acquiring step of acquiring an application number from the transmission/reception record stored in said first storage means or the document data stored in said second storage means; and
a code for realizing an extracting step of extracting document data of a document stored in said second storage means and related to said application number by referring to a table storing data showing correspondence between an application number and an applicant name using said application number as a key.

23. An information processing apparatus for managing a document related to technical information, comprising:
determination means for determining a rule of a law relating to overseas transmission of said technical information; and
control means for controlling overseas transmission of said document depending on a determination result by said determination means.

24. The information processing apparatus according to claim 23, wherein said document relates to a document about a patent application, and is transmitted as electronic data.

25. The information processing apparatus according to claim 24, wherein said determination means determines the rule based on a filing date of said patent application.

26. The information processing apparatus according to claim 24, wherein said determination means determines the rule based on a flag stored in a server for managing said document.

27. The information processing apparatus according to claim 26, wherein said flag indicates whether or not a license has been acquired.

28. The information processing apparatus according to claim 23, wherein said control means transmits said document overseas through a network.

29. An information processing method for managing a document related to technical information, comprising the steps of:
determining a rule of a law relating to overseas transmission of said technical information; and
controlling overseas transmission of said document depending on a determination result obtained in said determining step.

30. A program storage medium storing a program for realizing an information processing method for managing a document related to technical information, comprising the steps of:
a code for realizing a determining step of determining a rule of a law relating to overseas transmission of the technical information; and
a code for performing a controlling step of controlling overseas transmission of said document depending on a determination result obtained in said determining step.
